(19) United States
(12) Patent Application Publication
(10) Pub. No.: US 2013/0118483 A1
(43) Pub. Date: May 16, 2013

(54) SOLID LIGNOCELLULOSIC HYDROLYSATE AND METHODS TO PREPARE A SOLID LIGNOCELLULOSIC HYDROLYSATE

(71) Applicants: Johnway Gao, Federal Way, WA (US); Dwight Anderson, Puyallup, WA (US); Benjamin Levie, Mercer Island, WA (US)

(72) Inventors: Johnway Gao, Federal Way, WA (US); Dwight Anderson, Puyallup, WA (US); Benjamin Levie, Mercer Island, WA (US)

(21) Appl. No.: 13/294,867

(22) Filed: Nov. 11, 2011

(51) Int. Cl. C13B 50/00; C13K 1/02

(52) U.S. Cl. 127/30; 127/37

(57) ABSTRACT

The present disclosure provides a solid lignocellulosic hydrolysate and methods to prepare the solid lignocellulosic hydrolysate from a woody biomass or an herbaceous biomass. The solid lignocellulosic hydrolysate may be used in the production of biofuels, bioproducts, and food products. The solid lignocellulosic hydrolysate allows for ease of storage, ease of transportation and handling of the solid lignocellulosic hydrolysate, and ease of use in biological or fermentation processes or chemical processes for the production of biofuel, bioproducts, chemicals and food products due to the bulk handling characteristics (e.g., solubility and rate of dissolution) of the solid lignocellulosic hydrolysate.

### FIELD

The present disclosure relates generally to a solid hydrolysate obtained from a lignocellulosic source, and more specifically to a solid hydrolysate obtained from woody or herbaceous biomass, as well as waste or recycled paper.

### BACKGROUND

Today, sugars (e.g., pure sucrose, pure fructose, pure glucose, pure dextrose) obtained from sugar cane, sugar beets, and starch are often supplied to the food industry. For example, table sugar is made up of pure sucrose, and corn syrup is made up of fructose and glucose. These sugars may also be supplied to the biofuels and biochemicals industries; however, the sugars used for biofuel and biochemical production may be obtained from other sources such as cellulosic or lignocellulosic biomass.

The sugars used for biofuel and biochemical production are typically obtained by hydrolyzing biomass. Enzymatic hydrolysis of cellulose and hemicellulose, for example, yields a hydrolysate (e.g., a sugar solution). The sugar titer of the hydrolysate has been observed to depend, in part, on the solid loading of the biomass. For example, it has been observed that a biomass solid loading greater than 20% w/w can have an inhibitory effect on enzymatic hydrolysis. See Hodge D B et al., Soluble and insoluble solids contributions to high-solids enzymatic hydrolysis of lignocellulose, Bioresource Technology 99 (2008) pp. 8940-8948.

The sugars obtained from hydrolysis of biomass can then be fermented or chemically processed to produce biofuels, biochemicals and other bioproducts. For example, Knauf and Kraus have shown that ethanol fermentation can produce up to 17% (v/v) ethanol. See Knauf M and Kraus K, Specific yeasts developed for modern ethanol production, Sugar Industry, vol. 131 (2006), pp. 753-758. To achieve the ethanol concentration described in Knauf and Kraus, however, a solid loading of biomass in an enzymatic hydrolysis and fermentation greater than the practical limit identified by Hodge et al. may be required.

Furthermore, handling and storing a cellulosic sugar solution for biofuel and biochemical production may have higher risk of microorganism contamination due to the water content in sugar solution. Sugar solutions may also require more packaging effort, storage space, and transportation and handling costs.

Thus, what is needed in the art is a hydrolysate that can be used for fermentation to produce biofuels, biochemicals and other bioproducts that has a high sugar content, without a high solid loading of the biomass in hydrolysis or in combined hydrolysis and fermentation. What is also needed is a solid hydrolysate that can be used for fermentation or chemical processing to produce biofuels, biochemicals and other bioproducts, and that can be easily stored, handled and transported.

### BRIEF SUMMARY

The present disclosure addresses this need in the art by providing a solid lignocellulosic hydrolysate that has a higher sugar composition and improved bulk handling properties, including a faster rate of dissolution, in comparison with the sugar solutions or solid sugars currently used in the art for production of biofuels, biochemicals and other bioproducts.

The present disclosure also provides methods to obtain such a solid hydrolysate from a lignocellulosic source, such as woody biomass (e.g., softwood, hardwood) or herbaceous biomass (e.g., switchgrass).

One aspect of the disclosure provides a solid lignocellulosic hydrolysate that includes monomeric glucose, monomeric xylose, monomeric mannose, monomeric arabinose and monomeric galactose, in which the glucose, xylose, mannose, arabinose and galactose are at least 50% by weight of the total weight of the solid lignocellulosic hydrolysate. In one embodiment, the glucose, xylose, mannose, arabinose and galactose are at least 55% by weight of the total weight of the solid lignocellulosic hydrolysate.

In some embodiments, the solid lignocellulosic hydrolysate has a solubility of at least 0.25 g/mL in water. In other embodiments, the solid lignocellulosic hydrolysate has a solubility of at least 0.4 g/mL in water.

In some embodiments, the solid lignocellulosic hydrolysate has a rate of dissolution of at least 0.01 moles sugar/kg final solution/second.

In some embodiments, less than 10% by weight relative to the total weight of the solid lignocellulosic hydrolysate is water. In certain embodiments, less than 1% by weight relative to the total weight of the solid lignocellulosic hydrolysate is water.

In some embodiments, less than 10% by weight relative to the total weight of the solid lignocellulosic hydrolysate is lignin. In certain embodiments, less than 10% by weight relative to the total weight of the solid lignocellulosic hydrolysate is one or more metals. The one or more metals may be selected from calcium, potassium, magnesium, manganese, sodium, silicon, and sulfur. In some embodiments, less than 10% by weight relative to the total weight of the solid lignocellulosic hydrolysate is ash. In other embodiments, less than 10% by weight relative to the total weight of the solid lignocellulosic hydrolysate are lignosulfonates.

In some embodiments, the solid lignocellulosic hydrolysate has a lignocellulosic hydrolysate source. The solid lignocellulosic hydrolysate has a total sugar composition of monomeric glucose, monomeric xylose, monomeric mannose, monomeric arabinose and monomeric galactose. The lignocellulosic hydrolysate source has a total sugar composition of polymeric glucose, polymeric xylose, polymeric mannose, polymeric arabinose and polymeric galactose. In certain embodiments, the total sugar composition of the solid lignocellulosic hydrolysate is at least 70% of the total sugar composition of the lignocellulosic hydrolysate source.

In some embodiments, the solid lignocellulosic hydrolysate is a solid softwood hydrolysate, a solid hardwood hydrolysate, a solid herbaceous biomass hydrolysate, a solid agricultural waste hydrolysate, a solid waste or recycled paper hydrolysate, or a combination thereof. In certain embodiments, the lignocellulosic hydrolysate source is a softwood, a hardwood, an herbaceous biomass, agricultural waste, waste or recycled paper, or a combination thereof.

In some embodiments, the solid lignocellulosic hydrolysate has a total monomeric sugar weight, in which the total monomeric sugar weight is between 50% and 90%, or between 55% and 85% relative to the total weight of the solid lignocellulosic hydrolysate.

In one embodiment, the solid lignocellulosic hydrolysate is a solid softwood hydrolysate. The solid softwood hydrolysate has a total monomeric sugar weight. In certain embodiments, between 50% and 70% of the total monomeric sugar weight is monomeric glucose, between 1% and 5% of the total monomeric sugar weight is monomeric xylose, between 1% and 5% of the total monomeric sugar weight is monomeric galactose, between 0.5% and 1% of the total monomeric sugar weight is monomeric arabinose, and between 1% and 5% of the total monomeric sugar weight is monomeric mannose.

In another embodiment, the solid lignocellulosic hydrolysate is a solid hardwood hydrolysate. The solid hardwood hydrolysate has a total monomeric sugar weight. In certain embodiments, between 40% and 85% of the total monomeric sugar weight is monomeric glucose, between 5% and 10% of the total monomeric sugar weight is monomeric xylose, between 0.1% and 5% of the total monomeric sugar weight is monomeric galactose, between 0.1% and 1% of the total monomeric sugar weight is monomeric arabinose, and between 1% and 5% of the total monomeric sugar weight is monomeric mannose.

In yet another embodiment, the solid lignocellulosic hydrolysate is a solid herbaceous biomass hydrolysate. The solid herbaceous biomass hydrolysate has a total monomeric sugar weight. In certain embodiments, between 65% and 70% of the total monomeric sugar weight is monomeric glucose, between 1% and 5% of the total monomeric sugar weight is monomeric xylose, between 1% and 5% of the total monomeric sugar weight is monomeric galactose, between 0.5% and 1% of the total monomeric sugar weight is monomeric arabinose, and between 0.5% and 1% of the total monomeric sugar weight is monomeric mannose.

In some embodiments, the solid lignocellulosic hydrolysate has a bulk density between 400 kg/m³ and 1600 kg/m³. In other embodiments, the solid lignocellulosic hydrolysate has a bulk density between 400 kg/m³ and 700 kg/m³. In yet other embodiments, the solid lignocellulosic hydrolysate has a particle size between 2 microns and 500 microns.

In certain embodiments, the solid lignocellulosic hydrolysate described herein may be used in producing one or more biofuels, biochemicals, alcohols, organic acids, amino acids, diol products, protein products, gaseous products, or lipid compounds. In one embodiment, the solid lignocellulosic hydrolysate described herein may be used in fermentation to produce a biofuel or a biochemical. In one embodiment, the solid lignocellulosic hydrolysate described herein may be used in biofuel production. In another embodiment, the solid lignocellulosic hydrolysate described herein may be used in producing one or more alcohols, organic acids, amino acids, diol products, protein products, gaseous products, or lipid compounds.

Another aspect provides a solid lignocellulosic hydrolysate that includes monomeric glucose, monomeric xylose, monomeric mannose, monomeric arabinose and monomeric galactose, in which the glucose, xylose, mannose, arabinose and galactose are at least 60% by weight of the total weight of the solid lignocellulosic hydrolysate, and in which the solid lignocellulosic hydrolysate has a solubility of at least 0.25 g/mL in water. In certain embodiments, the solid lignocellulosic hydrolysate has a solubility of at least 0.4 g/mL in water. In other embodiments, less than 40% by weight relative to the total weight of the solid lignocellulosic hydrolysate is water and lignin.

Yet another aspect provides a solid lignocellulosic hydrolysate that includes monomeric glucose, monomeric xylose, monomeric mannose, monomeric arabinose and monomeric galactose, in which the glucose, xylose, mannose, arabinose and galactose are at least 60% by weight of the total weight of the solid lignocellulosic hydrolysate, and in which less than 40% by weight relative to the total weight of the solid lignocellulosic hydrolysate is water, ash, lignin lignosulfonates and one or more metals. The one or more metals may be selected from calcium, potassium, magnesium, manganese, sodium, silicon, and sulfur.

Yet another aspect provides a solid lignocellulosic hydrolysate that includes monomeric glucose, monomeric xylose, monomeric mannose, monomeric arabinose and monomeric galactose, in which the glucose, xylose, mannose, arabinose and galactose are at least 60% by weight of the total weight of the solid lignocellulosic hydrolysate, and in which less than 10% by weight relative to the total weight of the solid lignocellulosic hydrolysate is water. In certain embodiments, less than 30% by weight relative to the total weight of the solid lignocellulosic hydrolysate is ash, lignin, lignosulfonates and one or more metals. The one or more metals may be selected from calcium, potassium, magnesium, manganese, sodium, silicon, and sulfur.

Yet another aspect provides a solid lignocellulosic hydrolysate that includes monomeric glucose, monomeric xylose, monomeric mannose, monomeric arabinose and monomeric galactose, in which the glucose, xylose, mannose, arabinose and galactose are at least 70% by weight of the total weight of the solid lignocellulosic hydrolysate, in which less than 10% by weight relative to the total weight of the solid lignocellulosic hydrolysate is water, and in which less than 20% by weight relative to the total weight of the solid lignocellulosic hydrolysate is lignin. In certain embodiments, the solid lignocellulosic hydrolysate has a bulk density between 400 kg/m³ and 1600 kg/m³. In other embodiments, the solid lignocellulosic hydrolysate has a bulk density between 400 kg/m³ and 700 kg/m³.

Another aspect of the disclosure provides a method of obtaining a solid lignocellulosic hydrolysate from a lignocellulosic biomass by: a) providing a lignocellulosic biomass; b) pretreating the lignocellulosic biomass to produce a pretreatment liquor and a pretreated biomass solid; c) separating the pretreated biomass solid from the pretreatment liquor; d) hydrolyzing the pretreated biomass solid to produce a lignocellulosic hydrolysate and residual solids; e) separating the residual solids from the lignocellulosic hydrolysate; and f) concentrating, drying and/or crystallizing the lignocellulosic hydrolysate to obtain a solid lignocellulosic hydrolysate.

In some embodiments, the method further includes filtering the pretreatment liquor after separation from the pretreated biomass solid; and combining the filtered pretreatment liquor with the pretreated biomass solid for hydrolysis in step (d) of the method described above to produce the lignocellulosic hydrolysate and the residual solids.

In other embodiments, the method further includes purifying the lignocellulosic hydrolysate after separating the residual solids and before obtaining the solid lignocellulosic hydrolysate. The purifying of the lignocellulosic hydrolysate may reduce the amount of one or more metals present in the solid lignocellulosic hydrolysate. The one or more metals may be selected from calcium, potassium, magnesium, manganese, sodium, silicon, and sulfur. In some embodiments, the lignocellulosic hydrolysate is purified by washing, ion exchange chromatography, active carbon filtration, filter sterilization, ultra-violet irradiation, radiation, thermal sterilization, or a combination thereof.

In other embodiments, the method further includes sizing the solid lignocellulosic hydrolysate. The solid lignocellulosic hydrolysate may be sized, for example, by using a hammer mill, a solid crusher, a sieve, or a combination thereof.

In some embodiments, the pretreatment is a sulfur dioxide treatment, sulfite treatment, bisulfite treatment, dilute acid treatment, strong acid treatment, dilute alkaline treatment, strong alkaline treatment, oxidative delignification, ozonolysis, ammonia fiber explosion (AFEX), organosolvent treatment, hot water treatment, ionic liquid treatment, steam explosion, biological incubation, or a combination thereof.

In some embodiments, the solid lignocellulosic hydrolysate includes monomeric glucose, monomeric xylose, monomeric mannose, monomeric arabinose and monomeric galactose. In certain embodiments, the lignocellulosic biomass includes polymeric glucose, polymeric xylose, polymeric mannose, polymeric arabinose and polymeric galactose.

In certain embodiments, the pretreated biomass is hydrolyzed by enzymatic hydrolysis, dilute acid hydrolysis, strong acid hydrolysis, ionic liquid hydrolysis, or a combination thereof. In one embodiment, the enzymatic hydrolysis employs cellulase, xylanase, beta-glucosidase, or a combination thereof.

In some embodiments, the residual solids include lignin. In certain embodiments, the residual solids are separated from the lignocellulosic hydrolysate by filtration, centrifugation, or a combination thereof. In one embodiment, the filtration is ultra-filtration. In other embodiments, a filter with a molecular weight cut-off (MWCO) size of between 5 kDa and 20 kDa is used for the ultra-filtration. In certain embodiments, a filter with a molecular weight cut-off (MWCO) size of 5 kDa, 10 kDa, 15 kDa or 20 kDa is used for the ultra-filtration.

In other embodiments, the lignocellulosic hydrolysate is dried by vacuum drying, spray drying, drum drying, fluidized bed drying, or a combination thereof.

In some embodiments, the method further includes filtering the pretreatment liquor. In certain embodiments where the method includes filtering of the pretreatment liquor, the method further includes purifying the pretreatment liquor to produce a purified pretreatment liquor; and concentrating, drying or crystallizing the purified pretreatment liquor to obtain a second solid lignocellulosic hydrolysate. The pretreatment liquor may be purified, for example, by ion exchange chromatography, active carbon filtration, filter sterilization, ultra-violet irradiation, radiation, thermal sterilization, or a combination thereof. In one embodiment, the pretreatment liquor is filtered by ultra-filtration. In some embodiments, the filtering of the pretreatment liquor separates lignosulfonates from the pretreatment liquor. In other embodiments, a filter with a molecular weight cut-off (MWCO) size of between 5 kDa and 20 kDa is used for the ultra-filtration. In certain embodiments, a filter with a molecular weight cut-off (MWCO) size of 5 kDa, 10 kDa, 15 kDa or 20 kDa is used for the ultra-filtration.

Another aspect provides a method of obtaining a solid lignocellulosic hydrolysate from a lignocellulosic biomass by: a) providing a lignocellulosic biomass; b) pretreating the lignocellulosic biomass to produce a pretreatment liquor and a pretreated biomass solid; c) separating the pretreatment liquor from the pretreated biomass solid; d) filtering the pretreatment liquor; and e) concentrating, drying and/or crystallizing the filtered pretreatment liquor to obtain a solid lignocellulosic hydrolysate. In some embodiments, the method further includes purifying the filtered pretreatment liquor before obtaining the solid lignocellulosic hydrolysate. In some embodiments, the pretreatment liquor is filtered by ultra-filtration. In some embodiments, a filter with a molecular weight cut-off (MWCO) size of between 5 kDa and 20 kDa is used for the ultra-filtration. In certain embodiments, a filter with a molecular weight cut-off (MWCO) size of 5 kDa, 10 kDa, 15 kDa or 20 kDa is used for the ultra-filtration.

Yet another aspect provides a method of obtaining a solid lignocellulosic hydrolysate from a lignocellulosic biomass by: a) providing a lignocellulosic biomass; b) pretreating the lignocellulosic biomass to produce a pretreatment liquor and a pretreated biomass solid; c) separating the pretreated biomass solid from the pretreatment liquor; d) filtering the pretreatment liquor; e) hydrolyzing the pretreated biomass solid and the pretreatment liquor to produce a lignocellulosic hydrolysate and residual solids; f) separating the residual solids from the lignocellulosic hydrolysate; and g) concentrating, drying and/or crystallizing the lignocellulosic hydrolysate to obtain a solid lignocellulosic hydrolysate. In some embodiments, the method further includes purifying the lignocellulosic hydrolysate after separating the residual solids and before obtaining the solid lignocellulosic hydrolysate. In certain embodiments, the pretreatment liquor is filtered by ultra-filtration. In some embodiments, a filter with a molecular weight cut-off (MWCO) size of between 5 kDa and 20 kDa is used for the ultra-filtration. In certain embodiments, a filter with a molecular weight cut-off (MWCO) size of 5 kDa, 10 kDa, 15 kDa or 20 kDa is used for the ultra-filtration.

### DESCRIPTION OF THE FIGURES

The present application can be best understood by reference to the following description taken in conjunction with the accompanying figures, in which like parts may be referred to by like numerals:

FIG. 1 depicts an exemplary process for converting solid pretreated biomass into a solid lignocellulosic hydrolysate;

FIG. 2 depicts an exemplary process for converting pretreatment liquor into a solid lignocellulosic hydrolysate; and

FIG. 3 depicts an exemplary process for converting solid pretreated biomass and its pretreatment liquor into a solid lignocellulosic hydrolysate.

### DETAILED DESCRIPTION

To provide a more thorough understanding of the present disclosure, the following description sets forth numerous specific details, such as specific configurations, parameters, examples, and the like. It should be recognized, however, that such description is not intended as a limitation on the scope of the present disclosure but is intended to provide a better description of the exemplary embodiments.

The following description relates to a solid lignocellulosic hydrolysate that can be obtained from woody biomass (e.g., softwood, hardwood), herbaceous biomass (e.g., switchgrass), or waste or recycled paper, and methods to prepare the solid lignocellulosic hydrolysate.

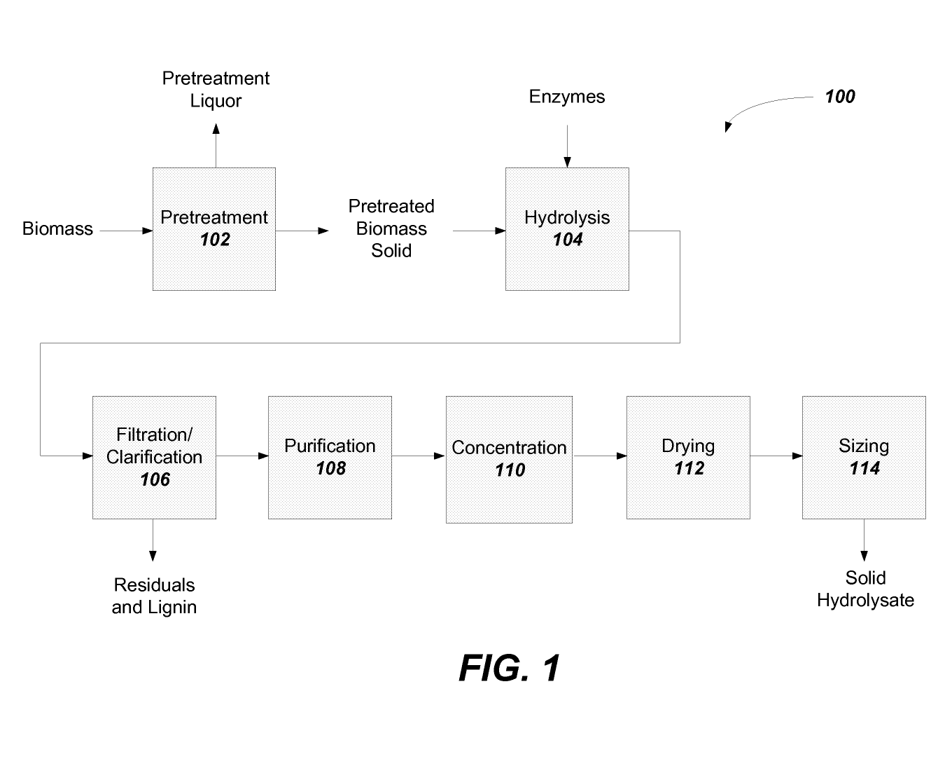

With reference to FIG. 1, process 100 is an exemplary embodiment that depicts the conversion of pretreated biomass into a solid lignocellulosic hydrolysate. The biomass used in process 100 is lignocellulosic biomass, including for example softwood, hardwood, and/or switchgrass. In step 102, the lignocellulosic biomass undergoes pretreatment to generate a pretreated biomass solid and a pretreatment liquor. Any pretreatment methods known in the art may be used in process 100, including for example sulfur dioxide treatment, sulfite treatment, bisulfite treatment, dilute acid treatment, strong acid treatment, dilute alkaline treatment, strong alkaline treatment, oxidative delignification, ozonolysis, ammonia fiber explosion (AFEX), organosolvent treatment, hot water treatment, ionic liquid treatment, steam explosion, biological incubation with fungi, yeast and/or bacteria, and enzymatic treatment. A combination of pretreatment methods may also be used.

In step 104, the pretreated biomass solid is enzymatically hydrolyzed (e.g., at around pH 5.3) to breakdown the polymeric sugars into monomeric sugars. In other exemplary embodiments, the pretreated biomass solid may be accomplished by dilute or strong acid hydrolysis, or by hot water hydrolysis.

It should be understood that prior to hydrolysis, several optional steps may be performed to improve hydrolysis. For example, in other embodiments, the pH of the pretreated biomass solid obtained from step 102 may be adjusted, and/or the pretreated biomass solid may be washed with water (e.g., 1 to 4 times of the solid weight) to reduce the levels of inhibitors that may affect hydrolysis.

Hydrolysis in step 104 produces a lignocellulosic hydrolysate, as well as un-hydrolyzed or un-digested cellulose fiber residuals and lignin. In step 106, the residuals and lignin are separated from the lignocellulosic hydrolysate by filtration and/or clarification. By using a sufficiently small screen size, filtration can remove lignosulfonates and/or other high molecular weight components, which may act as potential inhibitors downstream in fermentation to produce biofuels (e.g., ethanol) or biochemicals. Clarification can also remove larger residuals from the lignocellulosic hydrolysate.

In step 108, the lignocellulosic hydrolysate is purified to remove color pigment and/or metal ions. Any methods known in the art to purify the lignocellulosic hydrolysate may be used, including for example an active carbon column and an ion exchange column. A combination of methods to purify the lignocellulosic hydrolysate may also be used.

In steps 110 and 112, the lignocellulosic hydrolysate is concentrated and dried to produce a solid lignocellulosic hydrolysate. Any suitable methods known in the art to concentrate the lignocellulosic hydrolysate may be used. For example, the lignocellulosic hydrolysate can be concentrated using a multi-effect evaporator. Any suitable methods known in the art to dry the concentrated lignocellulosic hydrolysate may be used, including for example vacuum drying, spray drying, drum drying, and fluidized bed drying. A combination of drying methods may also be used.

It should be understood that, in other exemplary embodiments, the concentrated lignocellulosic hydrolysate may be crystallized rather than dried to produce a solid lignocellulosic hydrolysate. In yet other exemplary embodiments, the lignocellulosic hydrolysate is concentrated, crystallized and dried to produce a solid lignocellulosic hydrolysate.

In step 114, the solid lignocellulosic hydrolysate is sized to a particular particle size range that may be needed for subsequent processing (e.g., fermentation to produce biofuels or biochemicals). It should be understood, however, that one or more steps may be omitted or added from process 100. For example, in other exemplary embodiments, step 114 may be omitted if the particle size of the solid lignocellulosic hydrolysate obtained from steps 102-112 is suitable for subsequent processing (e.g., fermentation to produce biofuels or biochemicals).

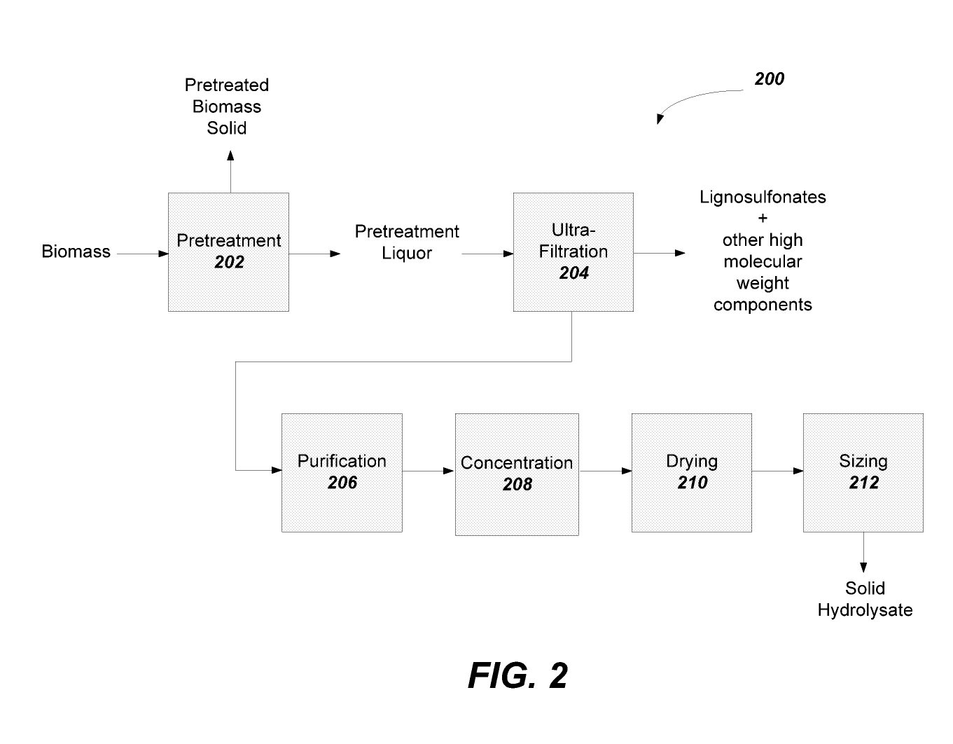

With reference again to FIG. 1, in step 102, the pretreatment liquor obtained from the pretreatment of the biomass can be further processed to obtain a solid lignocellulosic hydrolysate. With reference to FIG. 2, process 200 is an exemplary embodiment that depicts the conversion of the hydrolyzed sugars in the pretreatment liquor into a solid lignocellulosic hydrolysate. In step 202, lignocellulosic biomass undergoes pretreatment to generate a pretreated biomass solid and a pretreatment liquor. In step 204, the pretreatment liquor is filtered using an ultra-filter to remove lignosulfonates and other high molecular weight components. The filtered pretreatment liquor is then purified in step 206 to remove color pigment and/or metal ions. In steps 208 and 210, respectively, the purified pretreatment liquor is concentrated and dried to produce a solid lignocellulosic hydrolysate that can be subsequently sized (step 212).

It should be understood, however, that one or more steps may be omitted or added from process 200. For example, in other exemplary embodiments, crystallization may be an additional step in combination with concentration and drying to produce a solid lignocellulosic hydrolysate, or crystallization may replace drying as described in step 210.

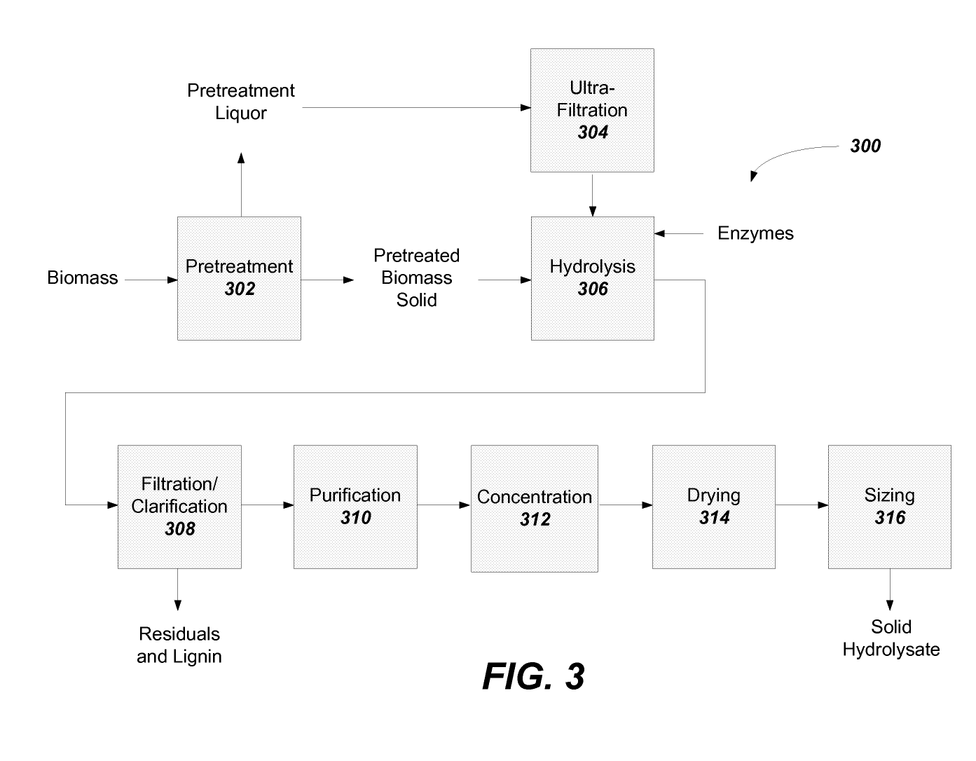

With reference to FIG. 3, process 300 depicts an exemplary embodiment in which pretreated biomass and pretreatment liquor are combined and converted into a solid lignocellulosic hydrolysate. In step 302, the lignocellulosic biomass undergoes pretreatment to generate a pretreated biomass solid and a pretreatment liquor. The pretreatment liquor is separated from the pretreated biomass solids, and is filtered using an ultra-filter in step 304. Both the pretreated biomass solids and the filtered pretreatment liquor are combined for hydrolysis in step 306. While step 306 involves enzymatic hydrolysis, it should be understood that in other exemplary embodiments, the pretreated biomass solid and filtered pretreatment liquor may be hydrolyzed by dilute or strong acid hydrolysis, or by hot water hydrolysis.

It should be understood, however, that one or more steps may be omitted or added from process 300. For example, in some embodiments, several optional steps may be performed prior to hydrolysis to improve the hydrolysis process. For example, in one embodiment, the pH of the pretreatment liquor before and/or after ultra-filtration in step 304 may be adjusted. In another embodiment, the pH of the pretreatment liquor obtained from step 302 is adjusted to approximately pH 5, and the pretreatment liquor is ultra-filtered to remove lignosulfonates in step 304. In yet other embodiments, the pH of the filtered pretreatment liquor may be further adjusted to approximately pH 10, and mixed with the pretreated biomass solid obtained from step 302 to give a final pH of 5.3 for hydrolysis in step 306.

Hydrolysis in step 306 produces a lignocellulosic hydrolysate, as well as un-hydrolyzed or un-digested cellulose fiber residuals and lignin. In step 308, filtration removes the residuals and lignin from the lignocellulosic hydrolysate, as well as lignosulfonates and/or other high molecular weight components. In step 310, the lignocellulosic hydrolysate is purified to remove color pigment and/or metal ions. In steps 312 and 314, the lignocellulosic hydrolysate is concentrated and dried to produce a solid hydrolysate.

It should be understood that, in other exemplary embodiments, crystallization can replace drying or be an additional step in combination with concentration and drying to produce a solid lignocellulosic hydrolysate.

As used herein, the term “about” refers to an approximation of a stated value within an acceptable range. Preferably, the range is +/−10% of the stated value.

### Lignocellulosic Source

The biomass source used to prepare a solid lignocellulosic hydrolysate in exemplary processes 100, 200, and 300 can be plant material that is made up of organic compounds relatively high in oxygen, such as carbohydrates, and may also contain a wide variety of other organic compounds.

Lignocellulosic biomass is a type of biomass that is made up of cellulose and hemicellulose bonded to lignin in plant cell walls. Lignocellulosic biomass can be grouped into four main categories: agricultural residues (e.g., corn stover, wheat straw, rice straw, sugarcane bagasse), dedicated energy crops (e.g., sugarcane, switchgrass), wood and wood residues (e.g., sawmill residuals, urban wastewood, pulp or paper mill screen rejects or fines, softwood chips, hardwood chips), and municipal paper waste. Any source of lignocellulosic biomass can be used, and some typical examples are described herein. Lignocellulosic biomass may originate from a woody biomass (e.g. softwood, hardwood) or an herbaceous biomass (e.g., switchgrass). Wood chips and bark materials from these sources can be used as a suitable biomass for the methods described herein.

As used herein, “a lignocellulosic hydrolysate source” refers to the biomass source from which a solid lignocellulosic hydrolysate may be obtained. In some embodiments, the lignocellulosic hydrolysate source has a total sugar composition of polymeric glucose, polymeric xylose, polymeric mannose, polymeric arabinose and polymeric galactose. The total sugar composition of the lignocellulosic hydrolysate source may vary from one type of lignocellulosic biomass to another.

### Pretreatment

Pretreatment of lignocellulosic biomass refers to one or more physical, chemical, physicochemical or biological methods to make cellulose and/or hemicellulose in the biomass more available for hydrolysis to produce monomeric sugars. Digestibility of cellulose in lignocellulosic biomass is hindered by various physicochemical, structure and compositional factors. As such, pretreatment of lignocellulosic biomass can help facilitate hydrolysis for sugar production. Pretreatment of lignocellulosic biomass can expose the cellulose and/or hemicellulose in the plant fibers by breaking down the lignin structure and disrupting the crystalline structure of cellulose and/or hemicellulose, thereby making the biomass more accessible for hydrolysis.

Unless indicated otherwise, a pretreatment does not include further processing steps such as separation of solid and liquid phases of the pretreatment product, or rinsing or conditioning of the solid or liquid product phases.

Physical pretreatment methods often involve size reduction to reduce the physical size of biomass. Numerous physical pretreatment methods are known in the art. Examples include chipping, grinding, shredding, chopping, milling, and pyrolysis. In one embodiment, biomass sizing may be employed as a physical pretreatment method to reduce the size of the wood chip to improve the time or temperature for hydrolysis. For woody feedstock in particular, biomass sizing is an effective practice for reducing inhibitors. Biomass sizing may reduce any conditioning requirement of the pretreatment liquor, better enabling it to serve as a diluent for hydrolysis.

Chemical pretreatment methods often involve removing chemical barriers to allow enzymes to access the cellulose for microbial destruction. Numerous chemical pretreatment methods are known in the art. Examples include acid hydrolysis, alkaline hydrolysis, ozonolysis, oxidative delignification, organic solvents, ionic liquids (IL), electrolyzed water, sulfite or bisulfite pulping, kraft pulping, and green liquor.

Physicochemical pretreatment methods include, for example, steam explosion with or without sulfur dioxide, ammonia fiber explosion (AFEX), and carbon dioxide explosion.

Biological pretreatment methods include, for example, various types of rot fungi (e.g., brown-, white-, and soft-rot fungi). Examples of other pretreatment methods include pulsed-electric-field pretreatment (PEF).

Applying one or more of the pretreatment methods described above to lignocellulosic biomass produces a pretreatment biomass composition, which can be separated into pretreatment liquor and pretreated biomass solids.

a) Pretreated Biomass Solids

Pretreated biomass solids make up the solid fraction produced from pretreatment of lignocellulosic biomass. Pretreated biomass solids are typically rich in cellulose. The pretreated biomass solids may contain inhibitors and have a different pH from the enzymatic hydrolysis pH and the fermentation pH. As a result, the pretreated biomass solids may be conditioned before hydrolysis or fermentation.

With reference to FIG. 1, in one exemplary embodiment, the pretreated biomass solids are separated from the pretreatment liquor, and then hydrolyzed to convert the polymeric sugars in the pretreated biomass solids into monomeric sugars in the lignocellulosic hydrolysate.

In some embodiments, the pH of pretreated biomass solids is adjusted prior to hydrolysis. Any suitable techniques to adjust the pH of the pretreated biomass solids to a suitable condition for hydrolysis may be employed. Examples include the use of buffers. In some embodiments, the pH of pretreated biomass solids may be adjusted to a range of 4-6.5. In one embodiment, the pH of pretreated biomass solids is adjusted to a pH of about 5.3.

In other embodiments, the pretreated biomass solids are washed (e.g., with water) to remove hydrolysis and fermentation inhibitors. In instances where the pretreated biomass solids are transported or stored before hydrolysis, washing can also promote safer material storage and transportation. Pretreated biomass solids may be washed with various solvents, including for example water. If pretreated biomass solids are not washed, pretreated biomass solids may be mixed with the pretreatment liquor for safer material storage and transportation. In other situations, pretreated biomass solids are unwashed.

b) Pretreatment Liquor

Pretreatment liquor, also known as prehydrolysate, is the liquid fraction produced from pretreatment of lignocellulosic biomass. The pretreatment liquor is typically rich in hemicellulose sugars and/or hemicellulose oligomers, along with lignin (and/or lignosulfonate in the case of sulfite pulping), extractives, furans, aldehydes, acetic acid, or other inhibitors that may restrict the growth and productivity of a fermenting organism.

The pretreatment liquor may have a pH range outside of the typical enzymatic hydrolysis pH range or typical fermentation pH range. As a result, in some embodiments, the pH of the pretreatment liquor may be adjusted prior to hydrolysis or fermentation. Moreover, in other embodiments, pretreatment liquor may be isolated from the pretreated biomass solids and used in a separate process for biofuel production, bioproduct production, or biogas production.

With reference to FIG. 2, in one exemplary embodiment, the pretreatment liquor can be separated from the pretreated biomass solids in the pretreatment process, and further processed to produce a solid lignocellulosic hydrolysate. In some embodiments, the pretreatment liquor is filtered (e.g., by ultra-filtration) and purified to remove non-sugar constituents such as lignosulfonates, other high molecular weight components and metals, and then concentrated, dried and/or crystallized to form a solid lignocellulosic hydrolysate.

With reference to FIG. 3, in another exemplary embodiment, the pretreatment liquor is filtered (e.g., by ultra-filtration) and combined with the pretreated biomass solids for hydrolysis. The lignocellulosic hydrolysate produced from the hydrolysis of the pretreatment liquor and pretreated biomass solids can then be filtered and purified to remove non-sugar constituents such as lignosulfonates, other high molecular weight components and metals, and then concentrated, dried and/or crystallized to form a solid lignocellulosic hydrolysate.

### Hydrolysis

Hydrolysis breaks down the polymeric sugars of the lignocellulosic biomass into monomeric sugars that can be used to prepare biofuels, biochemicals or other bioproducts. Hydrolysis of the pretreated biomass solids (with or without the pretreatment liquor) produces a lignocellulosic hydrolysate and residual solids.

Lignocellulosic hydrolysate is the liquid fraction produced from hydrolysis of pretreated biomass solids. The lignocellulosic hydrolysate is typically rich in monomeric sugars.

The residual solids are the solid fraction produced from the hydrolysis of the pretreated biomass solids. The residual solids may include, for example, un-hydrolyzed or un-digested cellulose fibers, and lignin.

Any suitable methods known in the art to hydrolyze the polymeric sugars of the lignocellulosic biomass may be used. For example, hydrolysis may be performed enzymatically or chemically.

a) Enzymatic Hydrolysis

In some embodiments, hydrolysis is performed enzymatically. Hydrolysis enzymes catalyze the conversion of biomass into monomeric and/or oligomeric sugars. Any suitable hydrolysis enzymes may be used in the methods described herein, including for example cellulases, beta-glucosidases, xylanases, endoxylanases, β-xylosidases, arabinofuranosidases, glucuronidases, and acetyl xylan esterases. Combinations of enzymes (i.e., enzyme cocktails) can also be tailored to the structure of a specific biomass feedstock to increase the level of hydrolysis and degradation.

In some embodiments, the hydrolysis enzyme(s) are applied to pretreated biomass solids that are washed or unwashed. In other embodiments, the hydrolysis enzyme(s) are applied to the pretreated biomass solids with or without the pretreatment liquor. In yet another embodiment where the pretreated biomass solids are in the form of a pulp cake or sheet, a concentrated enzyme is sprayed or spread onto the pulp cake or sheet.

In some embodiments, the hydrolysis enzyme(s) are applied to pretreated biomass in a way that achieves a roughly uniform distribution of enzymes. For example, the hydrolysis enzyme(s) may be sprayed onto the pretreated biomass to achieve uniform application. The methods described in U.S. application Ser. No. 12/816,999 (filed Jun. 16, 2010) may be used to spray one or more hydrolysis enzymes onto pretreated biomass. In other embodiments, the hydrolysis enzyme(s) may be applied to pretreated biomass in a mixing tank with agitation and circulation by an agitator or a circulation pump.

In applying one or more hydrolysis enzymes to pretreated biomass, various doses may be used. In one embodiment, 0.14 g of enzyme product per gram of pretreated biomass (dry basis) may be applied during the enzymatic hydrolysis. In another embodiment, 0.06 g of enzyme product per gram of pretreated biomass (dry basis) may be applied during the enzymatic hydrolysis. Further in another embodiment, 0.04 g of enzyme product per gram of pretreated biomass (dry basis) may be applied during the enzymatic hydrolysis. In another embodiment, 0.02 g of enzyme product per gram of pretreated biomass (dry basis) may be applied during the enzymatic hydrolysis. It should be understood that the enzyme product can vary depending on source and enzyme product concentration.

The duration for enzymatic hydrolysis may vary depending on the lignocellulosic source, the enzyme(s) used, the enzyme dosage, and the solid loading of pretreated biomass. In some embodiments, the enzymatic hydrolysis process is 24 hours, 48 hours, 72 hours, or 96 hours.

b) Chemical Hydrolysis

In other embodiments, hydrolysis is performed chemically. Suitable chemical hydrolysis methods may include, for example, dilute acid hydrolysis (using organic acids or inorganic acids), strong acid hydrolysis (using organic acids or inorganic acids), hot water hydrolysis, or hydrolysis mediated with ionic liquid.

### Filtration

In some embodiments, filtration may be used in the methods described herein to remove undigested pretreated biomass, insoluble lignin and other materials. Filtration may be applied to the lignocellulosic hydrolysate and/or the pretreatment liquor.

Any suitable methods known in the art, or a combination of methods, may be used for filtration. For example, a coarse or fine filter may be used. A coarse filter may be used to remove the larger insoluble particles, whereas a fine filter may be used to remove the smaller insoluble particles. In one embodiment, an ultra-filter is used. An ultra-filter may be used to remove, for example, lignosulfonates. The ultra-filter may have a molecular-weight-cut-off (MWCO) size of 5 kDa, 10 kDa, 15 kDa or 20 kDa. In one embodiment, an ultra-filter with a MWCO of about 10 kDa is used.

### Purification

In some embodiments, purification may be used in the methods described herein to remove color pigments and metal ions. Purification may be applied to the lignocellulosic hydrolysate and/or the pretreatment liquor. In certain embodiments, the lignocellulosic hydrolysate and/or the pretreatment liquor may be purified after filtration.

Any suitable methods known in the art, or a combination of methods, may be used for purification. For example, in some embodiments, a wash, an ion exchange column, an active carbon column, filter sterilization, thermal sterilization, UV irradiation, and radiation may be used for purification.

Concentration, Drying and/or Crystallization

Concentration, drying and/or crystallization may be used in the methods described herein to convert the lignocellulosic hydrolysate into a solid lignocellulosic hydrolysate. A combination of concentration, drying and crystallization may be used. In one embodiment, the lignocellulosic hydrolysate is concentrated before drying. In another embodiment, the lignocellulosic hydrolysate is concentrated before crystallization. In yet another embodiment, concentration is performed before crystallization, followed by drying.

a) Concentration

Concentration of the lignocellulosic hydrolysate allows for the control of the sugar titer or solid content in the lignocellulosic hydrolysate. Any suitable methods known in the art may be used for concentration, including for example a vacuum evaporator, a multi-effect evaporator, or a membrane-based separation (e.g., pervaporation).

It should be understood, however, that if the sugar titer or solid content is high enough for drying, concentration may not be needed.

b) Drying

Any suitable methods known in the art may be used for drying, including for example vacuum drying, spray drying, drum drying, and fluidized bed drying.

It should be understood that a combination of drying methods may be used. For example, in some embodiments, the lignocellulosic hydrolysate is drum dried before spray drying to obtain a solid lignocellulosic hydrolysate.

It should also be understood that a combination of drying methods may be used with the concentration methods described above. For example, in some embodiments, the lignocellulosic hydrolysate undergoes multi-effect evaporation before drum drying to obtain a solid lignocellulosic hydrolysate. In yet other embodiments, the lignocellulosic hydrolysate undergoes multi-effect evaporation before spray drying to obtain a solid lignocellulosic hydrolysate.

c) Crystallization

Any suitable methods known in the art may be used for crystallization. In some embodiments, the lignocellulosic hydrolysate is first concentrated to a higher sugar concentration (e.g., using a vacuum evaporator or a multi-effect evaporator), and then seeded with a small amount of fine sugar to initiate the sugar crystallization process. The hydrolysate crystals are grown, and then separated and harvested by filtration or centrifugation. The un-crystallized hydrolysate may be recycled, purified, and recrystallized upon further concentration in a vacuum evaporator or a multi-effect evaporator. It should be understood that, if the reactor is run under vacuum, the crystallization reactor may serve as a vacuum evaporator to further concentrate the hydrolysate before the crystal seeding process.

### Sizing

In some embodiments, the solid lignocellulosic hydrolysate is sized for subsequent fermentation processes to produce biofuels, biochemicals, or other bioproducts. In some embodiments, the solid lignocellulosic hydrolysate is sized between 2 microns and 500 microns. In other embodiments, the solid lignocellulosic hydrolysate is sized between 10 microns and 250 microns, between 50 microns and 200 microns, or between 100 microns and 150 microns. In yet other embodiments, the solid lignocellulosic hydrolysate is sized less than 500 microns, less than 400 microns, less than 300 microns, less than 200 microns, or less than 100 microns.

Any suitable methods known in art the art may be used to size the solid lignocellulosic hydrolysate, including for example a hammer mill, a solid crusher, and a sieve. A combination of sizing methods may be also used.

### Solid Lignocellulosic Hydrolysate

The solid lignocellulosic hydrolysate has a total sugar composition of monomeric glucose, monomeric xylose, monomeric mannose, monomeric arabinose and monomeric galactose. The lignocellulosic source from which the solid lignocellulosic hydrolysate is obtained has a total sugar composition of polymeric glucose, polymeric xylose, polymeric mannose, polymeric arabinose and polymeric galactose. The methods described herein can produce a solid lignocellulosic hydrolysate, which has a total sugar composition. In some embodiments, the total sugar composition of the solid lignocellulosic hydrolysate is at least 70%, at least 75%, at least 80%, at least 85%, at least 90%, or at least 95% of the total sugar composition of the lignocellulosic hydrolysate source.

a) Sugar Content

With reference to FIG. 1, the solid lignocellulosic hydrolysate is the solid product obtained from the lignocellulosic hydrolysate. The solid lignocellulosic hydrolysate includes monomeric glucose, monomeric xylose, monomeric mannose, monomeric arabinose and monomeric galactose. In some embodiments, the glucose, xylose, mannose, arabinose and galactose are at least 50%, at least 55%, at least 60%, at least 65%, at least 70%, at least 75%, at least 80%, at least 85%, at least 90%, or at least 85% by weight of the total weight of the solid lignocellulosic hydrolysate. In other embodiments, the glucose, xylose, mannose, arabinose and galactose are between 55% and 95%, between 60% and 90%, between 65% and 85%, between 70% and 80%, between 70% and 90%, or between 80% and 95% by weight of the total weight of the solid lignocellulosic hydrolysate.

The total monomeric sugar composition may vary depending on the process used to obtain the solid lignocellulosic hydrolysate. For example, the total monomeric sugar composition may be affected by the amount of lignin solubilized during pretreatment, or the purity of the cellulose before hydrolysis.

In some embodiments, the solid lignocellulosic hydrolysate has a total monomeric sugar content between 50% and 90%, between 50% and 80%, between 55% and 85%, between 60% and 85%, between 65% and 90% or between 70% and 95% by weight of the total weight of the solid lignocellulosic hydrolysate.

In certain embodiments, the glucose is between 50% and 90%, between 40% and 91%, between 65% and 92% by weight of the total weight of the solid lignocellulosic hydrolysate. The monomeric glucose content of the solid lignocellulosic hydrolysate may vary depending, for example, on the enzymes used for hydrolysis (e.g., cellulase, beta-glucosidase, with or without xylanase and mannanase and other enzymes). The xylose, mannose, arabinose and galactose sugar contents may vary depending on the amount of pretreatment liquor included in the sugar solution to be dried and the amount of lignosulfonate removed.

Additionally, in certain embodiments, the hemicellulose sugar content may vary depending on the lignocellulosic source and the amount of lignosulfonates present in the lignocellulose hydrolysate. In some embodiments, the hemicellulose sugar content is between 7% and 10% or between 3% and 7% by weight of the total weight of the solid lignocellulosic hydrolysate.

The relative monomeric sugar ratios of the solid lignocellulosic hydrolysate may vary depending on the process used to obtain the solid lignocellulosic hydrolysate and the lignocellulosic source used.

In some embodiments where the solid lignocellulosic hydrolysate is a solid softwood hydrolysate, between 50% and 70% of the total monomeric sugar weight is monomeric glucose, between 1% and 5% of the total monomeric sugar weight is monomeric xylose, between 1% and 5% of the total monomeric sugar weight is monomeric galactose, between 0.5% and 1% of the total monomeric sugar weight is monomeric arabinose, and between 1% and 5% of the total monomeric sugar weight is monomeric mannose.

In some embodiments where the solid lignocellulosic hydrolysate is a solid hardwood hydrolysate, between 40% and 85% of the total monomeric sugar weight is monomeric glucose, between 5% and 10% of the total monomeric sugar weight is monomeric xylose, between 0.1% and 5% of the total monomeric sugar weight is monomeric galactose, between 0.1% and 1% of the total monomeric sugar weight is monomeric arabinose, and between 1% and 5% of the total monomeric sugar weight is monomeric mannose.

In some embodiments where the solid lignocellulosic hydrolysate is a solid herbaceous biomass hydrolysate (e.g., a solid switchgrass hydrolysate), between 65% and 70% of the total monomeric sugar weight is monomeric glucose, between 1% and 5% of the total monomeric sugar weight is monomeric xylose, between 1% and 5% of the total monomeric sugar weight is monomeric galactose, between 0.5% and 1% of the total monomeric sugar weight is monomeric arabinose, and between 0.5% and 1% of the total monomeric sugar weight is monomeric mannose.

As discussed above, with reference to FIG. 2, a solid lignocellulosic hydrolysate can also be obtained from the pretreatment liquor. In some embodiments, the glucose is between 5% and 40%, or between 10% and 35% by weight of the total weight of the solid lignocellulosic hydrolysate. In other embodiments, the hemicellulose is between 60% and 95%, or between 65% and 90% by weight of the total weight of the solid lignocellulosic hydrolysate.

As discussed above, with reference to FIG. 3, a solid lignocellulosic hydrolysate can also be obtained from the pretreated biomass solids and the pretreatment liquor combined. In some embodiments, the glucose is between 40% and 90% by weight of the total weight of the solid lignocellulosic hydrolysate. In other embodiments, the hemicellulose is between 5% and 20% by weight of the total weight of the solid lignocellulosic hydrolysate.

b) Water Content and Content of Other Non-Sugar Constituents

The methods described herein produce a solid lignocellulosic hydrolysate that has a reduced amount of water and other non-sugar constituents, including for example ash, lignin, lignosulfonates, and one or more metals.

In some embodiments, less than 10%, less than 8%, less than 5%, less than 1%, less than 0.01% by weight relative to the total weight of the solid lignocellulosic hydrolysate is water.

In some embodiments, less than 10%, less than 5% or less than 1% by weight relative to the total weight of the solid lignocellulosic hydrolysate is ash.

In some embodiments, less than 10%, less than 5% or less than 1% by weight relative to the total weight of the solid lignocellulosic hydrolysate is lignin.

In some embodiments, less than 10%, less than 5% or less than 1% by weight relative to the total weight of the solid lignocellulosic hydrolysate are lignosulfonates.

In some embodiments, less than 10%, less than 5% or less than 1% by weight relative to the total weight of the solid lignocellulosic hydrolysate is one or more metals. The one or more metals may include, for example, calcium, potassium, magnesium, manganese, sodium, silicon, and sulfur.

In some embodiments, less than 30%, less than 25%, less than 20%, less than 15%, less than 10%, less than 5% or less than 1% by weight relative to the total weight of the solid lignocellulosic hydrolysate are water, ash, lignin, lignosulfonates and one or more metals (e.g., calcium, potassium, magnesium, manganese, sodium, silicon, and sulfur).

c) Solubility and Rate of Dissolution

The solid lignocellulosic hydrolysate is soluble in water, which makes this solid lignocellulosic hydrolysate useful for subsequent fermentation to produce a biofuel, a biochemical, or other bioproducts.

In some embodiments, the solid lignocellulosic hydrolysate has a solubility of at least 0.25 g/mL, at least 0.3 g/mL, at least 0.35 g/mL, at least 0.4 g/mL, at least 0.5 g/mL, at least 0.6 g/mL, at least 0.7 g/mL, or at least 0.75 g/mL in water.

The solid lignocellulosic hydrolysate prepared according to the methods described herein typically has a higher rate of dissolution in water compared to other solid sugars that are currently commercially available. In some instances, the solid lignocellulosic hydrolysate dissolves at least 1, 2, 3 or 4 times faster than other solid sugars that are currently commercially available.

In some embodiments, the solid lignocellulosic hydrolysate has a rate of dissolution of at least 0.01 moles sugar/kg final solution/second, at least 0.02 moles sugar/kg final solution/second, at least 0.03 moles sugar/kg final solution/second, or at least 0.04 moles sugar/kg final solution/second. In other embodiments, the solid lignocellulosic hydrolysate has a rate of dissolution of between 0.01-1 moles sugar/kg final solution/second, between 0.01-0.1 moles sugar/kg final solution/second, between 0.02-0.1 moles sugar/kg final solution/second, between 0.03-0.1 moles sugar/kg final solution/second, between 0.04-0.1 moles sugar/kg final solution/second, between 0.04-0.08 moles sugar/kg final solution/second, or between 0.04-0.65 moles sugar/kg final solution/second.

The rate of dissolution may be determined or measured according to any methods known in the art. It should be understood that the rate of dissolution may be affected by various factors including, for example, the shaking or agitation conditions and the temperature. In some embodiments, the rate of dissolution can be measured under a shaking condition used in a fermentation process (e.g., at a shaking or agitation speed of 120 r.p.m.). Such shaking conditions used in fermentation are, for example, described in Watanabe et al., Selection of stress-tolerant yeasts for simultaneous saccharification and fermentation (SSF) of very high gravity (VHG) potato mash to ethanol, Bioresource Technology 101 (2010) pp. 9710-9714). In some embodiments, dissolution occurs when the solid lignocellulosic hydrolysate added to a medium (e.g., water) is no longer visible as a solid.

In other embodiments, the solid lignocellulosic hydrolysate dissolves in water in less than 20 minutes, less than 10 minutes, less than 5 minutes, less than 2 minutes, less than 1 minute, less than 30 seconds, less than 20 seconds, less than 10 seconds, or less than 5 seconds. In one embodiment, the solid lignocellulosic hydrolysate dissolves in a fermentation medium in 20 seconds to 30 seconds. In another embodiment, the solid lignocellulosic hydrolysate with a 30%-35% solid loading dissolves in a fermentation medium in less than 30 seconds or less than 20 seconds. It should be understood, however, that the solid loading in water may affect the amount it takes to dissolve in water. For example, a solid loading of the solid lignocellulosic hydrolysate greater than 35% may take a longer time to dissolve.

Further, it should be understood that the solid lignocellulosic hydrolysate may dissolve in solvents that may be suitable for fermentation to produce a biofuel, biochemical or other bioproduct. The solvents may include water, or combinations of one or more solvents and water.

d) Bulk Density

The bulk density of the solid lignocellulosic hydrolysate may affect its rate of dissolution. In certain embodiments, a lower bulk density of the solid lignocellulosic hydrolysate may result in faster dissolution of the solid lignocellulosic hydrolysate in water. Bulk density refers to the mass of particles compared to the total volume occupied by the particles. The total volume may include particle volume, inter-particle volume and internal pore volume. As used herein, the bulk densities provided herein are the values before compression of the solid lignocellulosic hydrolysate to remove any voids.

In some embodiments, the solid lignocellulosic hydrolysate has a bulk density between 400 kg/m³ and 1600 kg/m³, between 600 kg/m³ and 1600 kg/m³, between 800 kg/m³ and 1600 kg/m³, between 400 kg/m³ and 900 kg/m³, between 600 kg/m³ and 900 kg/m³, between 800 kg/m³ and 900 kg/m³, between 400 kg/m³ and 700 kg/m³, between 500 kg/m³ and 700 kg/m³, between 600 kg/m³ and 700 kg/m³, between 400 kg/m³ and 600 kg/m³, or between 400 kg/m³ and 500 kg/m³. In other embodiments, the solid lignocellulosic hydrolysate has a bulk density less than 1600 kg/m³, less than 1200 kg/m³, less than 900 kg/m³, less than 800 kg/m³, less than 700 kg/m³, less than 650 kg/m³, less than 600 kg/m³, less than 550 kg/m³, less than 500 kg/m³, less than 450 kg/m³, or less than 400 kg/m³.

In certain embodiments, the solid lignocellulosic hydrolysate has a crystalline bulk density less than 900 kg/m³, less than 800 kg/m³, less than 700 kg/m³, less than 650 kg/m³, less than 600 kg/m³, less than 550 kg/m³, less than 500 kg/m³, less than 450 kg/m³, or less than 400 kg/m³.

### Uses of the Solid Lignocellulosic Hydrolysate

a) Biological Conversion or Fermentation

The solid lignocellulosic hydrolysate prepared according to the methods described herein can be used to prepare one or more biofuels (e.g., ethanol, propanol, butanol) or a bioproduct (e.g., amino acids, organic acids, pharmaceuticals, specialty chemicals). In some embodiments, the solid lignocellulosic hydrolysate can be used to prepare alcohol compounds (e.g., ethanol, butanol, isobutanol), organic acids (e.g., acetic acid, lactic acid, citric acid), amino acids (e.g., lysine, methionine, alanine, glutamic acid), diols (e.g., propanediol and butanediol), protein products (e.g., enzymes, polypeptides), gaseous products (e.g., as biogas, methane, hydrogen, carbon dioxide) and lipids.

The solid lignocellulosic hydrolysate can be used for subsequent fermentation with one or more fermenting organisms to produce a fermentation product, e.g., a biofuel, a biochemical, or other bioproducts. The fermentation process may use fermentation organisms such as yeast, fungi, mold, algae, bacteria (e.g., Escherichia coli and Clostridium), or a mixture of these organisms.

The methods and conditions suitable for sugar fermentation into a biofuel or a bioproduct are well known in the art. For example, Sedlak and Ho teach one way to produce ethanol from sugar fermentation of cellulosic biomass, such as corn stover. See e.g., Miroslav Sedlak and Nancy W. Y. Ho, Production of ethanol from cellulosic biomass hydrolysates using genetically engineered Saccharomyces yeast capable of cofermenting glucose and xylose, Applied Biochemistry and Biotechnology, 113-116: 403-416 (2004); Watanabe et al., Selection of stress-tolerant yeasts for simultaneous saccharification and fermentation (SSF) of very high gravity (VHG) potato mash to ethanol, Bioresource Technology 101 (2010) pp. 9710-9714.

In some embodiments, fermentation may occur in less than 24 hours, or for 24 hours to 72 hours, or for 36 hours to 60 hours.

In some embodiments, fermentation converts 60% to 100% of the solid lignocellulosic hydrolysate to the fermentation product. In other embodiments, fermentation converts at least 60%, at least 70%, at least 80%, at least 90% or at least 95% of the solid lignocellulosic hydrolysate to the fermentation product.

b) Chemical Catalyses

The solid lignocellulosic hydrolysate prepared according to the methods described herein can also be used in various chemical catalyses to produce alcohols, ketones, aldehydes, alkanes, alkenes, organic acids, polyols, furans (e.g., hydroxymethylfurfural, furandicarboxylic acid, dimethylfuran), gasoline, diesel, jet fuel, and gaseous products (e.g., hydrogen, carbon dioxide).

c) Food Products

The solid lignocellulosic hydrolysate prepared according to the methods described herein can also be used to produce food products, including for example soft drinks, beer, wine and vinegar.

Although individual features of the compositions and methods described herein may be included in different claims, these may be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate. Where a composition or process ‘comprises’ one or more specified items or steps, others can also be included. The invention also contemplates, however, that the described composition or process may be used without other items or steps and thus it includes the recited composition or process ‘consisting of’ or ‘consisting essentially of’ the recited items, materials or steps, as those terms are commonly understood in patent law.

### EXAMPLES

The following Examples are merely illustrative and are not meant to limit any aspects of the present disclosure in any way.

### Materials and Reagents

a) Biomass

Softwood thinnings (early harvest of pine softwood 12-15 years after planting and before final harvest that may be sourced to a pulp mill), hardwood (maple chips) and switchgrass (Alamo variety) were used as the biomass in the Examples below. Table 1 below summarizes the carbohydrate composition of the biomass used. The carbohydrate composition of each biomass was determined by converting the polymeric sugars in the feedstock into monomeric sugars such as glucose, xylose, mannose, arabinose and galactose. Results are reported as the original polymeric composition of the biomass. As seen in Table 1 below, the total polymeric sugar composition observed for softwood, hardwood and switchgrass was 56%, 57% and 59%, respectively.

TABLE 1
Carbohydrate composition of biomass used

| Polymer Sugar of | | | |
|---|---|---|---|
| Total Biomass | Softwood | Hardwood | Switchgrass |
| Arabinan (%) | 1.29 | 0.52 | 3.30 |
| Galactan (%) | 2.74 | 0.53 | 1.04 |
| Glucan (%) | 37.8 | 39.0 | 33.2 |
| Xylan (%) | 6.45 | 14.8 | 21.7 |
| Mannan (%) | 7.89 | 2.56 | 0.22 |
| Total (%) | 56.17 | 57.41 | 59.46 |

b) Biomass Pretreatment Reagents

Sulfonation using calcium bisulfite was used for biomass pretreatment. Calcium bisulfite was produced by constantly purging pure sulfur dioxide into a calcium oxide solution. The final calcium bisulfite concentration contained about 3-4% total sulfur dioxide, of which about 1% was free sulfur dioxide. The pH of this calcium bisulfite solution was about 1.4.

c) Hydrolysis Reagents

Cellulase (Celluclast, Sigma Catalog #C-2730), Cellic® CTec2 enzyme product (Novozymes), beta-glucosidase (Novozymes-188, Sigma Catalog #C-6105), and xylanase (Sigma Catalog #X2753) were used accordingly in the enzymatic hydrolysis experiments described below after biomass pretreatment.

For enzymatic hydrolysis, a pre-mixed enzyme cocktail (Sigma mixture) containing cellulase (99.5 mg/mL), beta-glucosidase (42.5 mg/mL) and xylanase (3.4 mg/mL) was used. The total enzyme protein titer was 145.5 mg/mL. In some of the Examples described below, Cellic® CTec2 enzyme product was used instead of cellulase.

d) Ethanol Fermentation Reagents

A yeast strain Saccharomyces cerevisiae T2 was obtained from Dr. Sheldon Duff at the University of British Columbia. This yeast strain was used for ethanol fermentation described in some of the Examples described below.

### Pretreatment Procedures

Before pretreating the biomass used in the Examples below, the softwood, hardwood and switchgrass were fractured with a BearCat garden chipper with a ¾″ screen to obtain the chipped materials. The 3-mm round-hole fines from the chipped materials were removed to avoid circulation problems in the pretreatment reactor.

The chipped softwood and hardwood were individually pretreated in a one cubic foot reactor with an acid sulfite pretreatment consisting of 12.5% calcium bisulfite on wood with a single step temperature schedule: ramped from 90° C. to 155° C. in 15 minutes and held at 155° C. for 120 minutes. After cooking, the liquor was drained and the cooked chips were collected. The cooked chips were then sent to an Alpine grinder, without any water, to refine the chips into a pulp. The pulp batch numbers were CS10220A for the pretreated hardwood and CS10228A for the pretreated softwood.

The chipped switchgrass was pretreated with an 18.4% calcium bisulfite loading on dry biomass with a single step temperature schedule: ramped from 90° C. to 155° C. in 15 minutes and held at 155° C. for 75 minutes. After cooking, the liquor was drained and the cooked switchgrass was collected. The cooked switchgrass was not further refined. The pulp batch number was CS10226A for the pretreated switchgrass.

Under the same temperature scheme described above at 12.5% calcium bisulfite loading, another batch (CS10222A) was also run for hardwood to provide additional materials for enzymatic hydrolysis and sugar production described in the Examples below. The pretreatment temperature at 155° C. was close to 160° C. to 170° C., which were temperatures reported in some acid sulfite pulp processes by Seaman in 1954 (U.S. Pat. No. 2,698,234) and by Wolfinger et al. in 2004 (Martin G. Wolfinger & Herbert Sixta, Modeling of the acid sulfite pulping process—Problem definition and theoretical approach for a solution with the main focus on the recovery of cooking chemicals, Lenzinger Berichte, 83: 35-45 (2004)).

Table 2 below summarizes the carbohydrate compositions of the pretreated biomass. The carbohydrate composition of each pretreated biomass was determined by converting the polymeric sugars in the pretreated biomass into monomeric sugars such as glucose, xylose, mannose, arabinose and galactose. As seen in Table 2 below, the total polymeric sugar composition observed for softwood, hardwood and switchgrass was 43%, 62% and 60%, respectively. These pretreated biomass materials were used for the enzymatic hydrolysis and for the solid hydrolysate production.

TABLE 2
Carbohydrate composition of pretreated biomass

| | | Pretreated | Pretreated |
|---|---|---|---|
| Sugar Polymer of | Pretreated Softwood | Hardwood | Switchgrass |
| Pretreated Biomass | (CS10228A) | (CS10220A) | (CS10226A) |
| Arabinan (%) | 0.27 | 0.14 | 0.28 |
| Galactan (%) | 0.81 | 0.20 | 0.18 |
| Glucan (%) | 38.8 | 56.6 | 54.7 |
| Xylan (%) | 1.38 | 4.24 | 4.18 |
| Mannan (%) | 2.08 | 1.12 | 0.23 |
| Total (%) | 43.34 | 62.3 | 59.57 |

A pretreatment liquor (or prehydrolysate) was also produced for each biomass. Table 3 below summarizes the carbohydrate composition of the pretreatment liquor sugar composition. In some Examples described below, these pretreatment liquor streams were used along with the pretreated biomass solid in the enzymatic hydrolysis process.

TABLE 3
Carbohydrate composition of pretreatment liquor

| | Softwood | Hardwood | Switchgrass |
|---|---|---|---|
| Sugar Monomers in | Pretreatment | Pretreatment | Pretreatment |
| Pretreatment Liquor | Liquor | Liquor | Liquor |
| Arabinose (%) | 0.104 | 0.067 | 0.227 |
| Galactose (%) | 0.268 | 0.150 | 0.057 |
| Glucose (%) | 0.843 | 0.726 | 0.289 |
| Xylose (%) | 0.499 | 1.746 | 2.499 |
| Mannose (%) | 0.910 | 0.453 | 0.050 |
| Total (%) | 2.624 | 3.142 | 3.122 |

### Example 1

### Hydrolysis of Pretreated Softwood without its Pretreatment Liquor

The pretreated softwood was washed with 4× water, and the pH of the pretreated softwood was adjusted to about 5.3 using calcium oxide. After washing and pH adjustment, the pretreated softwood was pressed to achieve a solid content of about 40%, and then hydrolyzed in a shake flask at a solid concentration of 18.8% and an enzyme dosage (Sigma mixture) of 30 mg enzyme protein/g (glucan and xylan). The enzyme dosage also corresponded to 0.111 g enzyme product/dry gram of pulp materials.

A 50 mmol sodium citrate buffer was used during the hydrolysis. The total hydrolysis volume was 500 mL. The hydrolysis temperature was controlled at 50° C. and the shaking speed was 200 rpm. Most of the hydrolysis was completed in about 72 hours. The hydrolysis was taken out at about 120 hours to ensure a more complete hydrolysis.

Enzymatic hydrolysis of the pretreated softwood produced a softwood hydrolysate. Table 4 below summarizes the sugar titers of the softwood hydrolysate at 72 hours, 96 hours and 120 hours. A total sugar titer of 8.3% was observed in the softwood hydrolysate after 120 hours.

TABLE 4
Sugar Titer in Softwood Hydrolysate

| | | | | Arabi- | | Total |
|---|---|---|---|---|---|---|
| Time | Glucose | Xylose | Galactose | nose | Mannose | Sugar |
| (hr) | (%) | (%) | (%) | (%) | (%) | Titer (%) |
| 72 | 7.33 | 0.06 | 0.14 | 0.06 | 0.12 | 7.72 |
| 96 | 7.42 | 0.06 | 0.15 | 0.06 | 0.11 | 7.79 |
| 120 | 7.77 | 0.18 | 0.15 | 0.08 | 0.11 | 8.29 |

### Example 2

### Hydrolysis of Pretreated Hardwood with its Pretreatment Liquor

Unwashed pretreated hardwood and its pretreatment liquor were combined and used in hydrolysis. The combination of the pretreatment biomass with its pretreatment liquor increased sugar titer, while minimizing hydrolysis water usage.

Before hydrolysis, the pH of the pretreatment liquor was first adjusted to 7.5 using potassium hydroxide in the presence of a sodium citrate buffer. The pretreated hardwood was sterilized in an autoclave, and then was combined with the pretreatment liquor to achieve a final solid content of about 18%. The pH of the hydrolysis was controlled at around a pH of 5.3 using a 50 mmol sodium citrate buffer.

The CTec2 enzyme dosage for hydrolysis was 0.133 g enzyme product/dry gram of pulp materials. The total hydrolysis volume was 424 mL. The hydrolysis temperature was controlled at 50° C. and the shaking speed was 200 rpm. The hydrolysis was completed in about 72 hours.

Enzymatic hydrolysis of the pretreated hardwood produced a hardwood hydrolysate. Table 5 below summarizes the sugar titers in the hardwood hydrolysate at 24 hours and 76 hours. A total sugar titer of 15.8%, which included sugar contribution from the pretreatment liquor, was observed after 76 hours.

TABLE 5
Sugar Titer in Hardwood Hydrolysate

| | | | | Arabi- | | Total |
|---|---|---|---|---|---|---|
| Time | Glucose | Xylose | Galactose | nose | Mannose | Sugar |
| (hr) | (%) | (%) | (%) | (%) | (%) | Titer (%) |
| 24 | 9.94 | 2.20 | 0.08 | 0.06 | 0.52 | 12.80 |
| 76 | 12.73 | 2.28 | 0.13 | 0.07 | 0.55 | 15.75 |

### Example 3

### Hydrolysis of Pretreated Switchgrass without Pretreatment Liquor

The pretreated switchgrass was washed with 4× water, and the pH of the pretreated switchgrass was adjusted to about 5.3 using calcium oxide. After washing and pH adjustment, the pretreated switchgrass was pressed to achieve a solid content of about 41%, and then hydrolyzed in a shake flask at a solid concentration of 18.8% at an enzyme dosage (Sigma mixture) of 30 mg enzyme protein/g (glucan+xylan). The enzyme dosage also corresponded to 0.133 g enzyme product/dry gram of pulp materials.

A 50 mmol sodium citrate buffer was used during the hydrolysis. The total hydrolysis volume was 500 mL. The hydrolysis temperature was controlled at 50° C. and the shaking speed was 200 rpm. Most of the hydrolysis was completed in about 72 hours; however, the hydrolysis was stopped at 120 hours to ensure a more complete hydrolysis.

Enzymatic hydrolysis of the pretreated switchgrass produced a switchgrass hydrolysate. Table 6 below summarizes the sugar titers in the switchgrass hydrolysate at 72 hours, 96 hours and 120 hours. A total sugar titer of 13.6% was observed after 120 hours.

TABLE 6
Sugar Titer in Switchgrass Hydrolysate

| | | | | Arabi- | Mannose | Total |
|---|---|---|---|---|---|---|
| Time | Glucose | Xylose | Galactose | nose | | Sugar |
| (hr) | (%) | (%) | (%) | (%) | (%) | Titer (%) |
| 72 | 12.06 | 0.35 | 0.00 | 0.06 | 0.06 | 12.53 |
| 96 | 12.55 | 0.43 | 0.12 | 0.03 | 0.03 | 13.17 |
| 120 | 12.74 | 0.48 | 0.22 | 0.09 | 0.07 | 13.59 |

### Example 4

### Hydrolysis of Pretreated Softwood and Ultra-Filtered Softwood Pretreatment Liquor

The pretreatment liquor obtained after softwood pretreatment was ultra-filtered using a 10 kDa molecular-weight-cut-off (MWCO) filter to the lignosulfonates. The filtered softwood pretreatment liquor was combined with the pretreated softwood to achieve a final solid content of 17%. The combined pretreated softwood and ultra-filtered softwood pretreatment liquor was then hydrolyzed using CTec2 enzymes. The enzyme dosages used in this Example are summarized in Table 7 below. The hydrolysis temperature was controlled at 50° C. and the shaking speed was 200 rpm. The hydrolysis time was completed in 96 hours. Table 7 also compares the effect of the buffer and ultra-filtration of the pretreatment liquor on glucose yields after hydrolysis.

TABLE 7
Effects of Buffer and Ultra-Filtration of Softwood Pretreatment Liquor
on Enzymatic Hydrolysis of Pretreated Softwood

| | | Liquor | | Glucose | | |
|---|---|---|---|---|---|---|
| | | Filtered | Enzyme | Titer | | |
| | | w/ | Dose | (%) from | Normalized | Average |
| Test | Pulp | 10K Da | (g/g dry | Pulp | Glucose | Normalized |
| No. | (%) | MWCO | pulp) | only | Yield (%) | Yield (%) |
| Control | 17 | citrate | 0.140 | 9.0 | 100.8 | 100.0 |
| 1 | | buffer | | | | |
| Control | 17 | citrate | 0.140 | 8.9 | 99.2 | |
| 2 | | buffer | | | | |
| Control | 17 | citrate | 0.061 | 7.2 | 80.2 | 87.5 |
| 3 | | buffer | | | | |
| Control | 17 | citrate | 0.061 | 8.5 | 94.9 | |
| 4 | | buffer | | | | |
| Control | 17 | citrate | 0.044 | 6.9 | 77.6 | 82.9 |
| 5 | | buffer | | | | |
| Control | 17 | citrate | 0.044 | 7.9 | 88.2 | |
| 6 | | buffer | | | | |
| Control | 17 | citrate | 0.021 | 6.7 | 75.4 | 80.1 |
| 7 | | buffer | | | | |
| Control | 17 | citrate | 0.021 | 7.6 | 84.9 | |
| 8 | | buffer | | | | |
| 1 | 17 | yes | 0.140 | 8.8 | 98.1 | 96.5 |
| 2 | 17 | yes | 0.140 | 8.5 | 94.8 | |
| 1 | 17 | no | 0.140 | 8.6 | 96.6 | 97.3 |
| 2 | 17 | no | 0.140 | 8.8 | 98.1 | |
| 3 | 17 | yes | 0.061 | 8.0 | 89.2 | 86.7 |
| 4 | 17 | yes | 0.061 | 7.5 | 84.2 | |
| 3 | 17 | no | 0.061 | 7.1 | 78.9 | 80.2 |
| 4 | 17 | no | 0.061 | 7.3 | 81.5 | |
| 5 | 17 | yes | 0.044 | 7.7 | 85.7 | 80.7 |
| 6 | 17 | yes | 0.044 | 6.8 | 75.6 | |
| 5 | 17 | no | 0.044 | 6.5 | 72.8 | 73.9 |
| 6 | 17 | no | 0.044 | 6.7 | 75.0 | |
| 7 | 17 | yes | 0.021 | 6.4 | 71.3 | 74.6 |
| 8 | 17 | yes | 0.021 | 7.0 | 78.0 | |
| 7 | 17 | no | 0.021 | 6.0 | 66.5 | 67.0 |
| 8 | 17 | no | 0.021 | 6.0 | 67.6 | |

The normalized yield of glucan conversion to glucose was calculated by dividing the glucose amount of each test with filtered or unfiltered liquor by the maximum amount of glucose, at an excessive enzyme dosage at 0.140 g enzyme product/dry gram of pulp materials in the citrate buffer control test.

As seen in Table 7 above, ultra-filtration of the softwood pretreatment liquor increased the net glucan hydrolysis yield by 6.5% (i.e., comparing the average normalized yield of tests 3 and 4 with and without ultra-filtration of liquor), 6.8% (i.e., comparing the average normalized yield of tests 5 and 6 with and without ultra-filtration), and 7.6% (i.e., comparing the average normalized yield of tests 7 and 8 with and without ultra-filtration), respectively for CTec2 enzyme dosages 0.061, 0.044 and 0.021 g enzyme product/dry gram of pulp materials. These results demonstrate that ultra-filtration of the softwood pretreatment liquor increased sugar yield, especially at lower enzyme dosages where enzyme dosage may limit the overall extent of hydrolysis.

As seen again in Table 7 above, hydrolysis of the control tests with the citrate buffer increased the net glucan hydrolysis yield compared to tests with unfiltered softwood pretreatment liquor by 2.7% (i.e., comparing the average normalized yield of control tests 1 and 2 with tests 1 and 2 without ultra-filtration), 7.3% (i.e., comparing the average normalized yield of control tests 3 and 4 with tests 3 and 4 without ultra-filtration), 9.0% (i.e., comparing the average normalized yield of control tests 5 and 6 with tests 5 and 6 without ultra-filtration) and 13.1% (i.e., comparing the average normalized yield of control tests 7 and 8 with tests 7 and 8 without ultra-filtration), respectively for enzyme dosages 0.140, 0.061, 0.044 and 0.021 g enzyme product/dry gram of pulp materials. These results demonstrate that ultra filtration improves overall glucan hydrolysis nearly as much as is achieved with a clean citrate buffer.

### Example 5

### Vacuum Drying of an Unfiltered Softwood Hydrolysate to Produce a Solid Softwood Hydrolysate

The softwood hydrolysate from Example 1 was vacuum dried at 65° C. to produce a solid softwood hydrolysate. A similar softwood hydrolysate was also prepared according to the procedures described in Example 1 using CTec2 at an enzyme dosage of 0.061 g enzyme product/dry gram of pulp materials. The total monomeric sugar compositions of the two solid softwood hydrolysates are summarized in Table 8 below. As seen in Table 8 below, the total sugar compositions of the solid softwood hydrolysate obtained from the Sigma mixture was 58% and from CTec2 was 69%.

TABLE 8
Total sugar composition of solid softwood hydrolysate (unfiltered)

| | | | | | | | Total |
|---|---|---|---|---|---|---|---|
| | | | | | | | Sugar |
| | | Glu- | Xy- | Galac- | Arabi- | Man- | Com- |
| Test | Enzyme | cose | lose | tose | nose | nose | position |
| No. | Products | (%) | (%) | (%) | (%) | (%) | (%) |
| LH3 | Sigma | 52.0 | 1.2 | 2.3 | 0.9 | 1.9 | 58.3 |
| | Mixture | | | | | | |
| LH4 | CTec2 | 62.5 | 2.8 | 1.9 | 0.6 | 1.6 | 69.3 |

### Example 6

### Vacuum Drying of an Ultra-Filtered Softwood Hydrolysate to Produce a Solid Softwood Hydrolysate

The softwood hydrolysate from Example 1 was first filtered through an ultra-filter with a MWCO of 10 kDa. The filtered softwood hydrolysate was then vacuum dried at 65° C. to produce a solid softwood hydrolysate. A similar softwood hydrolysate was also prepared according to the procedures described in Example 1 using Sigma enzyme mixture at an enzyme dosage of 0.111 g enzyme product/dry dram of pulp materials and using CTec2 at an enzyme dosage of 0.061 g enzyme product/dry gram of pulp materials. This softwood hydrolysate prepared using CTec2 was also ultra-filtered with a 10 kDa MWCO filter and dried under vacuum at 65° C. The total monomeric sugar compositions of the two solid softwood hydrolysates are summarized in Table 9 below. As seen in Table 9 below, the total sugar compositions of the solid softwood hydrolysate obtained from the Sigma mixture was 74% and from CTec2 was 78%.

TABLE 9
Total sugar composition of solid softwood hydrolysate (ultra-filtered)

| | | | | | | | Total |
|---|---|---|---|---|---|---|---|
| | | | | | | | Sugar |
| | | Glu- | Xy- | Galac- | Arabi- | Man- | Com- |
| Test | Enzyme | cose | lose | tose | nose | nose | position |
| No. | Products | (%) | (%) | (%) | (%) | (%) | (%) |
| LH3 | Sigma | 66.5 | 2.4 | 1.8 | 1.0 | 1.9 | 73.5 |
| | Mixture | | | | | | |
| LH4 | CTec2 | 69.8 | 1.7 | 3.0 | 1.0 | 2.3 | 77.8 |

### Example 7

### Vacuum Drying of an Unfiltered Switchgrass Hydrolysate to Produce a Solid Switchgrass Hydrolysate

The switchgrass hydrolysate from Example 3 was vacuum dried at 65° C. to produce a solid switchgrass hydrolysate. A similar switchgrass hydrolysate was also prepared according to the procedures described in Example 3 using Sigma enzyme mixture at an enzyme dosage of 0.133 g enzyme product/dry dram of pulp materials and using and using CTec2 at an enzyme dosage of 0.073 g enzyme product/dry gram of pulp materials. The total monomeric sugar compositions of the two solid switchgrass hydrolysates are summarized in Table 10 below. As seen in Table 10 below, the total sugar compositions of the solid switchgrass hydrolysate obtained from the Sigma mixture was 70% and from CTec2 was 71%.

TABLE 10
Total sugar composition of solid switchgrass hydrolysate (unfiltered)

| | | | | | | | Total |
|---|---|---|---|---|---|---|---|
| | | | | | | | Sugar |
| | | Glu- | Xy- | Galac- | Arabi- | Man- | Com- |
| Test | Enzyme | cose | lose | tose | nose | nose | position |
| No. | Products | (%) | (%) | (%) | (%) | (%) | (%) |
| LH1 | Sigma | 60.7 | 4.7 | 2.2 | 1.1 | 0.9 | 69.7 |
| | Mixture | | | | | | |
| LH2 | CTec2 | 65.4 | 2.7 | 1.3 | 0.6 | 0.8 | 70.8 |

### Example 8

### Vacuum Dry of an Ultra-Filtered Switchgrass Hydrolysate to Produce a Solid Switchgrass Hydrolysate

The switchgrass hydrolysate from Example 3 was first filtered through an ultra-filter with a MWCO of 10 kDa. The filtered switchgrass hydrolysate was then vacuum dried at 65° C. to produce a solid switchgrass hydrolysate. A similar pretreated switchgrass hydrolysate was also prepared according to the procedures described in Example 3 using Sigma enzyme mixture at an enzyme dosage of 0.133 g enzyme product/dry gram of pulp materials and using CTec2 at an enzyme dosage of 0.073 g enzyme product/dry gram of pulp materials. This switchgrass hydrolysate prepared using CTec2 was ultra-filtered with a 10 kDa MWCO filter and dried under vacuum at 65° C. The total monomeric sugar compositions of the two solid switchgrass hydrolysates are summarized in Table 11 below. As seen in Table 11 below, the total sugar compositions of the solid switchgrass hydrolysate obtained from the Sigma mixture was 71% and from CTec2 was 72%.

TABLE 11
Total sugar composition of solid switchgrass hydrolysate (ultra-filtered)

| | | Glu- | | Galac- | Arabi- | Man- | Total Sugar |
|---|---|---|---|---|---|---|---|
| Test | Enzyme | cose | Xylose | tose | nose | nose | Composition |
| No. | Products | (%) | (%) | (%) | (%) | (%) | (%) |
| LH1 | Sigma | 64.0 | 4.3 | 1.4 | 0.8 | 0.9 | 71.3 |
| | Mixture | | | | | | |
| LH2 | CTec2 | 67.5 | 2.8 | 0.8 | 0.5 | 0.5 | 72.0 |

### Example 9

### Metal and Sulfur Contents in Solid Softwood and Switchgrass Hydrolysates

The major metal ions and sulfur contents of the solid softwood and switchgrass hydrolysates were analyzed. Table 12 below summarizes the metal content of the solid softwood and switchgrass hydrolysates, obtained from the ultra-filtered hydrolysate samples. As seen in Table 12 below, the total major metal contents were approximately 4.56% and 3.55%, respectively, for the solid softwood hydrolysate and for the solid switchgrass hydrolysate.

TABLE 12
Major metal content

| | Ca | K | Mg | Mn | Na | Si | Total Major Metal |
|---|---|---|---|---|---|---|---|
| Source | (%) | (%) | (%) | (%) | (%) | (%) | Content (%) |
| Softwood | 0.384 | 1.198 | 0.024 | 0.008 | 2.919 | 0.027 | 4.56 |
| Hydrolysate | | | | | | | |
| Switchgrass | 0.266 | 1.072 | 0.020 | 0.002 | 2.144 | 0.042 | 3.55 |
| Hydrolysate | | | | | | | |

It should be noted that during hydrolysis, the use of the 50 mmol sodium citrate buffer for pH control added sodium (Na) to the final ash content. Eliminating the use of the sodium citrate buffer in an automated pH control process may reduce the sodium content observed in Table 12 above.

The sulfur contents of the solid softwood and switchgrass hydrolysates are shown in Table 13 below. It should be noted that most of the sulfur may have come from calcium bisulfite residuals from the pretreatment.

TABLE 13
Sulfur content

| Source | Sulfur (%) |
|---|---|
| Softwood Hydrolysate | 0.541 |
| Switchgrass Hydrolysate | 1.257 |

### Example 10

### Spray Drying of an Ultra-Filtered Softwood Hydrolysate to Produce a Solid Softwood Hydrolysate

Softwood hydrolysate prepared according to the procedure set forth in Example 1 was filtered through an ultra-filter with a MWCO of 10 kDa. The filtered softwood hydrolysate was then spray-dried at 150° C. with a product outlet temperature of 84° C. to produce a solid softwood hydrolysate. The total monomeric sugar composition of the solid softwood hydrolysate is summarized in Table 13 below. As seen in Table 14 below, the total sugar composition of the solid softwood hydrolysate was 74%. The weighted average C5/C6 sugar molecular weight was observed to be 178.5 g/mole.

TABLE 14
Total sugar composition of solid softwood hydrolysate (ultra-filtered)

| | | | | | | | Total |
|---|---|---|---|---|---|---|---|
| | | | | | | | Sugar |
| | | Glu- | Xy- | Galac- | Arabi- | Man- | Com- |
| Test | Enzyme | cose | lose | tose | nose | nose | position |
| No. | Products | (%) | (%) | (%) | (%) | (%) | (%) |
| LH3S | Sigma | 62.2 | 2.5 | 3.6 | 1.6 | 3.7 | 73.5 |
| | Mixture | | | | | | |

### Example 11

### Spray Drying of an Ultra-Filtered Switchgrass Hydrolysate to Produce a Solid Switchgrass Hydrolysate

Switchgrass hydrolysate prepared according to the procedure set forth in Example 3 was filtered through an ultra-filter with a MWCO of 10 kDa. The filtered hydrolysate was then spray-dried at 150° C. with a product outlet temperature of 84° C. to produce a solid switchgrass hydrolysate. The total monomeric sugar composition of the solid switchgrass hydrolysate is summarized in Table 15 below. As seen in Table 15 below, the total sugar composition of the solid switchgrass hydrolysate was 72%. The weighted average C5/C6 sugar molecular weight was observed to be 178.8 g/mole.

TABLE 15
Total sugar composition of solid switchgrass hydrolysate (ultra-filtered)

| | | | | | | | Total |
|---|---|---|---|---|---|---|---|
| | | | | | | | Sugar |
| | | Glu- | Xy- | Galac- | Arabi- | Man- | Com- |
| Test | Enzyme | cose | lose | tose | nose | nose | position |
| No. | Products | (%) | (%) | (%) | (%) | (%) | (%) |
| LH1S | Sigma | 65.6 | 2.7 | 1.8 | 0.5 | 1.3 | 72.0 |
| | Mixture | | | | | | |

### Example 12

### Spray Drying of an Unfiltered Hardwood Hydrolysate and Hardwood Pretreatment Liquor to Produce a Solid Hardwood Hydrolysate

Hardwood hydrolysate prepared according to the procedure set forth in Example 2 was combined with hardwood pretreatment liquor. The hardwood hydrolysate and hardwood pretreatment liquor were spray-dried at 150° C. with a product outlet temperature of 82-85° C. to produce a solid hardwood hydrolysate. Table 16 below summarizes the total monomeric sugar composition of the solid hardwood hydrolysate. As seen in Table 16 below, the total sugar composition of the solid hardwood hydrolysate was 58%.

TABLE 16
Total sugar composition of solid hardwood hydrolysate (unfiltered)

| | | | | Galac | Arabi- | Man- | Total Sugar |
|---|---|---|---|---|---|---|---|
| Test | Enzyme | Glucose | Xylose | tose | nose | nose | Composition |
| No. | Products | (%) | (%) | (%) | (%) | (%) | (%) |
| 4HPS | CTec2 | 39.6 | 9.4 | 3.4 | 1.4 | 4.2 | 57.9 |

### Example 13

### Ethanol Fermentation Using Solid Softwood Hydrolysate

Before ethanol fermentation, the Saccharomyces cerevisiae T2 yeast seed was first grown in a complex medium containing 1% yeast extract and 2% peptone, supplemented with 3% glucose. The stock seed culture was incubated in a shake flask on an orbital shaking incubator controlled at 38° C. and 200 rpm for 18-20 hours. The yeast seed culture was then centrifuged and the yeast seed pellet was dissolved in a small volume of 100 mmol sodium citrate buffer. The yeast seed was inoculated at 2 g/L dry cell weight in the fermentation tests.

The solid softwood hydrolysate from Example 10 was added directly to a sterilized complex medium containing 0.5% yeast extract and 1% peptone. The solid softwood hydrolysate dissolved almost instantly in 20 seconds at 120 rpm shaking agitation.

After the yeast seed was inoculated, the fermentation was conducted in a total 5-mL volume in 25 mL Erlenmeyer flasks shaking at 120 rpm. The initial glucose concentration was 22.8%. The fermentation temperature was controlled at 38° C. and the pH was controlled at around 5 by daily pH adjustment.

Table 17 below summarizes the results of the solid softwood hydrolysate fermentation. As seen in Table 17 below, the ethanol titer reached 8.04% within 48 hours, and most of the fermentation was observed to be completed.

TABLE 17
Ethanol fermentation of solid softwood hydrolysate

| Time | Glucose | Xylose | Galactose | Arabinose | Mannose | Ethanol |
|---|---|---|---|---|---|---|
| (hr) | (% w/v) | (% w/v) | (% w/v) | (% w/v) | (% w/v) | (% w/v) |
| 0 | 22.8 | 0.86 | 0.44 | 0.14 | 0.34 | 0.00 |
| 24 | 8.56 | 0.70 | 0.37 | 0.13 | 0.12 | 7.20 |
| 48 | 5.00 | 0.93 | 0.38 | 0.16 | 0.14 | 8.04 |

The ethanol yield produced from the solid softwood hydrolysate was observed to be 87.5%. The total ethanol yield in this Example was calculated as the total ethanol produced divided by the total sugar used in the fermentation and divided by 0.511, which is the factor that corresponds to a theoretical yield at 100% metabolic conversion. Since the current yeast strain primarily uses glucose, the ethanol yield is mainly from glucose.

### Example 14

### Ethanol Fermentation Using Solid Switchgrass Hydrolysate

Before ethanol fermentation, the Saccharomyces cerevisiae T2 yeast seed was first prepared in a complex medium according to the procedure set forth in Example 13.

The solid switchgrass hydrolysate powder from Example 10 was added directly to a sterilized complex medium containing 0.5% yeast extract and 1% peptone. The solid switchgrass hydrolysate dissolved almost instantly in 20 seconds at 120 rpm shaking agitation.

After the yeast seed was inoculated, the fermentation was conducted in a total 5-mL volume in 25 mL Erlenmeyer shake flasks shaking at 120 rpm. The initial glucose concentration was 22.4%. The fermentation temperature was controlled at 38° C. and the pH was controlled at around 5 by daily pH adjustment.

Table 18 below summarizes the results of solid switchgrass hydrolysate fermentation. As seen in Table 18 below, the ethanol titer reached 8.93% within 48 hours, and most of the fermentation was observed to be completed.

TABLE 18
Ethanol fermentation of solid switchgrass hydrolysate

| Time | Glucose | Xylose | Galactose | Arabinose | Mannose | Ethanol |
|---|---|---|---|---|---|---|
| (hr) | (% w/v) | (% w/v) | (% w/v) | (% w/v) | (% w/v) | (% w/v) |
| 0 | 22.44 | 1.48 | 0.36 | 0.20 | 0.16 | 0.00 |
| 24 | 4.98 | 1.72 | 0.53 | 0.12 | 0.04 | 8.15 |
| 48 | 2.05 | 1.50 | 0.37 | 0.12 | 0.11 | 8.93 |

The ethanol yield produced from the solid spray-dried switchgrass hydrolysate was observed to be 85.3%. The total ethanol yield in this Example was calculated as the total ethanol produced divided by the total sugar used in the fermentation and divided by 0.511, which is the factor that corresponds to a theoretical yield at 100% metabolic conversion. Since the current yeast strain primarily uses glucose, the ethanol yield is mainly from glucose.

### Example 15

### Comparing Rate of Dissolution of Solid Lignocellulosic Hydrolysate and Sigma Glucose Crystals

Solid softwood hydrolysate (LH3S) prepared according to the procedure set forth in Example 10 above, solid switchgrass hydrolysate (LH1S) prepared according to the procedure set forth in Example 11 above, and glucose crystals purchased from Sigma (product # G8270) were used in this Example.

To achieve a glucose titer of about 18.9% wt/wt, 1.52 g of solid softwood hydrolysate (33.0% wt/wt solid loading) were added to 3.08 ml of a standard fermentation complex medium; 1.45 g of solid switchgrass hydrolysate (31.5% wt/wt solid loading) were added to 3.15 ml of a standard fermentation complex medium; and 0.95 g of Sigma glucose crystals (20.6% wt/wt solid loading) were added to 3.65 mL of a standard fermentation complex medium. The complex medium used was prepared according to the procedure set forth in Example 13.

The tests were conducted in a 25 ml Erlenmeyer flask on an orbital shaking incubator at 120 r.p.m., at room temperature. The amount of time it took for the solid sample to dissolve in the complex medium was measured. The solid sample was considered to be dissolved when solids were no longer visible.

The solid softwood hydrolysate was observed to dissolve in about 20-31 seconds (rate of dissolution of 0.044-0.068 moles sugar/kg final solution/second). The solid switchgrass hydrolysate was observed to dissolve in about 20-30 seconds (rate of dissolution of 0.042-0.064 moles sugar/kg final solution/second). In contrast, the Sigma glucose crystals were observed to dissolve in about 215 to 240 seconds (rate of dissolution of 0.0047 to 0.0053 moles sugar/kg final solution/second).

Thus, the solid softwood and switchgrass hydrolysates were observed to dissolve about an order of magnitude faster than the commercially available solid sugar.

What is claimed is:

1. A solid lignocellulosic hydrolysate comprising monomeric glucose, monomeric xylose, monomeric mannose, monomeric arabinose and monomeric galactose,
wherein the glucose, xylose, mannose, arabinose and galactose are at least 50% by weight of the total weight of the solid lignocellulosic hydrolysate.

2. The solid lignocellulosic hydrolysate of claim 1 wherein the solid lignocellulosic hydrolysate has a solubility of at least 0.25 g/mL in water.

3. The solid lignocellulosic hydrolysate of claim 1 wherein the solid lignocellulosic hydrolysate has a rate of dissolution of at least 0.01 moles sugar/kg final solution/second.

4. The solid lignocellulosic hydrolysate of claim 1 wherein the solid lignocellulosic hydrolysate has a lignocellulosic hydrolysate source,
wherein the solid lignocellulosic hydrolysate has a total sugar composition of monomeric glucose, monomeric xylose, monomeric mannose, monomeric arabinose and monomeric galactose,
wherein the lignocellulosic hydrolysate source has a total sugar composition of polymeric glucose, polymeric xylose, polymeric mannose, polymeric arabinose and polymeric galactose, and
wherein the total sugar composition of the solid lignocellulosic hydrolysate is at least 70% of the total sugar composition of the lignocellulosic hydrolysate source.

5. The solid lignocellulosic hydrolysate of claim 1 wherein the solid lignocellulosic hydrolysate is a solid softwood hydrolysate, a solid hardwood hydrolysate, a solid herbaceous biomass hydrolysate, a solid agricultural waste hydrolysate, a solid waste or recycled paper hydrolysate, or a combination thereof.

6. The solid lignocellulosic hydrolysate of claim 1 wherein the solid lignocellulosic hydrolysate has a total monomeric sugar weight, wherein the total monomeric sugar weight is between 50% and 90% relative to the total weight of the solid lignocellulosic hydrolysate.

7. The solid lignocellulosic hydrolysate of claim 1 wherein the solid lignocellulosic hydrolysate is a solid softwood hydrolysate, wherein the solid softwood hydrolysate has a total monomeric sugar weight,
wherein between 50% and 70% of the total monomeric sugar weight is monomeric glucose,
wherein between 1% and 5% of the total monomeric sugar weight is monomeric xylose,
wherein between 1% and 5% of the total monomeric sugar weight is monomeric galactose,
wherein between 0.5% and 1% of the total monomeric sugar weight is monomeric arabinose, and
wherein between 1% and 5% of the total monomeric sugar weight is monomeric mannose.

8. The solid lignocellulosic hydrolysate of claim 1 wherein the solid lignocellulosic hydrolysate is a solid hardwood hydrolysate, wherein the solid hardwood hydrolysate has a total monomeric sugar weight,
wherein between 40% and 85% of the total monomeric sugar weight is monomeric glucose,
wherein between 5% and 10% of the total monomeric sugar weight is monomeric xylose,
wherein between 0.1% and 5% of the total monomeric sugar weight is monomeric galactose,
wherein between 0.1% and 1% of the total monomeric sugar weight is monomeric arabinose, and
wherein between 1% and 5% of the total monomeric sugar weight is monomeric mannose.

9. The solid lignocellulosic hydrolysate of claim 1 wherein the solid lignocellulosic hydrolysate is a solid herbaceous biomass hydrolysate, wherein the solid herbaceous biomass hydrolysate has a total monomeric sugar weight,
wherein between 65% and 70% of the total monomeric sugar weight is monomeric glucose,
wherein between 1% and 5% of the total monomeric sugar weight is monomeric xylose,
wherein between 1% and 5% of the total monomeric sugar weight is monomeric galactose,
wherein between 0.5% and 1% of the total monomeric sugar weight is monomeric arabinose, and
wherein between 0.5% and 1% of the total monomeric sugar weight is monomeric mannose.

10. The solid lignocellulosic hydrolysate of claim 1 wherein the solid lignocellulosic hydrolysate has a bulk density between 400 kg/m³ and 1600 kg/m³.

11. The solid lignocellulosic hydrolysate of claim 1 for use in producing one or more biofuels, biochemicals, alcohols, organic acids, amino acids, diol products, protein products, gaseous products, or lipid compounds.

12. A method of obtaining a solid lignocellulosic hydrolysate from a lignocellulosic biomass comprising:
a) providing a lignocellulosic biomass;
b) pretreating the lignocellulosic biomass to produce a pretreatment liquor and a pretreated biomass solid;
c) separating the pretreated biomass solid from the pretreatment liquor;
d) hydrolyzing the pretreated biomass solid to produce a lignocellulosic hydrolysate and residual solids;
e) separating the residual solids from the lignocellulosic hydrolysate; and
f) concentrating, drying and/or crystallizing the lignocellulosic hydrolysate to obtain a solid lignocellulosic hydrolysate.

13. The method of claim 12, further comprising:
filtering the pretreatment liquor after separation from the pretreated biomass solid; and
combining the filtered pretreatment liquor with the pretreated biomass solid for hydrolysis in step (d) to produce the lignocellulosic hydrolysate and the residual solids.

14. The method of claim 12, further comprising purifying the lignocellulosic hydrolysate after separating the residual solids and before obtaining the solid lignocellulosic hydrolysate.

15. The method of claim 12, further comprising sizing the solid lignocellulosic hydrolysate.

16. The method of claim 12, wherein the lignocellulosic hydrolysate is dried by vacuum drying, spray drying, drum drying, fluidized bed drying, or a combination thereof.

17. The method of claim 12, further comprising filtering the pretreatment liquor.

18. The method of claim 17, further comprising:
purifying the pretreatment liquor to produce a purified pretreatment liquor; and
concentrating, drying or crystallizing the purified pretreatment liquor to obtain a second solid lignocellulosic hydrolysate.

19. A method of obtaining a solid lignocellulosic hydrolysate from a lignocellulosic biomass comprising:
a) providing a lignocellulosic biomass;
b) pretreating the lignocellulosic biomass to produce a pretreatment liquor and a pretreated biomass solid;
c) separating the pretreatment liquor from the pretreated biomass solid;
d) filtering the pretreatment liquor; and
e) concentrating, drying and/or crystallizing the filtered pretreatment liquor to obtain a solid lignocellulosic hydrolysate.

20. The method of claim 19, further comprising purifying the filtered pretreatment liquor before obtaining the solid lignocellulosic hydrolysate.
